(19) United States
(12) Patent Application Publication
(10) Pub. No.: US 2026/0275785 A1
(43) Pub. Date: Sep. 17, 2026

(54) STORAGE COMPONENT AND REFRIGERATOR

(71) Applicants: QINGDAO HAIER REFRIGERATOR CO., LTD., Qingdao (CN); QINGDAO HAIER SMART TECHNOLOGY R & D CO., LTD., Qingdao (CN); HAIER SMART HOME CO., LTD., Qingdao (CN)

(72) Inventors: Kang LI, Qingdao (CN); Huagang LI, Qingdao (CN); Enpin XIA, Qingdao (CN); Changzhi WANG, Qingdao (CN)

(21) Appl. No.: 19/167,218

(22) PCT Filed: Mar. 20, 2024
(86) PCT No.: PCT/CN2024/082760

§ 371 Date: Sep. 19, 2025

(30) Foreign Application Priority Data
Mar. 21, 2023 (CN) 202310280484.9
Mar. 21, 2023 (CN) 202310282115.3
Mar. 21, 2023 (CN) 202310282140.1

(51) Int. Cl. E05D 7/081; E05D 3/18; F25D 23/02

(52) U.S. Cl. CPC E05D 7/081; E05D 3/18; F25D 23/028; E05Y 2800/296; E05Y 2900/31; F25D 2323/024

(57) ABSTRACT

The present application discloses a storage component and a refrigerator. The storage component includes a housing, a door and a hinge assembly; the door is pivotally connected to an opening side of the housing through the hinge assembly; the hinge assembly includes a main shaft, an auxiliary shaft configured to provide guidance for rotation of the door, and a main groove and an auxiliary groove corresponding to the main shaft and the auxiliary shaft respectively; during a pivoting process of the door, there exists a stage where the auxiliary shaft moves along an auxiliary shaft trajectory which is generally linear as a whole. The storage component provided by the present application has stable pivoting process.

The application claims priority to Chinese Patent Application No. 202310282140.1, filed on Mar. 21, 2023, entitled “Storage Component and Refrigerator”, Chinese Patent Application No. 202310280484.9, filed on Mar. 21, 2023, entitled “Storage Component and Refrigerator”, and Chinese Patent Application No. 202310282115.3, filed on Mar. 21, 2023, entitled “Storage Component and Refrigerator”, the entire contents of which are incorporated herein by reference.

### TECHNICAL FIELD

The present application relates to the field of household appliance technology, and particularly to a storage component and a refrigerator.

### BACKGROUND

Household appliances such as refrigerators exhibit an increasing door opening angle as the door opening process progresses. In prior arts, due the fixed-axis rotation mechanism, the door opening angle increases uniformly, resulting in a correspondingly consistent rotational movement of the door as the door opening angle expands. However, this approach leads to an unstable door pivoting process.

### SUMMARY

One of the objectives of the present application is to provide a storage component to address the technical issue of unstable door pivoting in the prior art.

One of the objectives of the present application is to provide a refrigerator.

To achieve one of the aforementioned objectives, an embodiment of the present application provides a storage component, comprising a housing, a door, and a hinge assembly; wherein the door is pivotally connected to an opening side of the housing through the hinge assembly; the hinge assembly comprises a main shaft, an auxiliary shaft configured to provide guidance for rotation of the door, a main groove corresponding to the main shaft, and an auxiliary groove corresponding to the auxiliary shaft; during a pivoting process of the door, there exists a stage where the auxiliary shaft moves along an auxiliary shaft trajectory which is generally linear as a whole.

As a further improvement of an embodiment of the present application, during an opening process of the door, the main shaft moves along a third main shaft trajectory, while the auxiliary shaft moves along a first auxiliary shaft trajectory; the third main shaft trajectory is generally curved, and the first auxiliary shaft trajectory is generally linear.

As a further improvement of an embodiment of the present application, the storage component is arranged at a side of an external environment component; the door comprises a second wall surface; when the door closes the opening side of the housing, the hinge assembly is close to a first side face of the external environment component, and the second wall surface is close to and parallel to the first side face; during an opening process of the door, relative to the door, there successively exists a stage where the auxiliary shaft moves along a third auxiliary shaft trajectory and a stage where the auxiliary shaft moves along a fourth auxiliary shaft trajectory; the third auxiliary shaft trajectory is generally linear, and the fourth auxiliary shaft trajectory is generally curved; the fourth auxiliary shaft trajectory is entirely located on a side of the third auxiliary shaft trajectory closer to the second wall surface.

As a further improvement of an embodiment of the present application, the storage component is arranged at a side of an external environment component; the door comprises a second wall surface; when the door closes the opening side of the housing, the hinge assembly is close to a first side face of the external environment component, and the second wall surface is close to and parallel to the first side face; during a closing process of the door, relative to the door, there successively exists a stage where the auxiliary shaft moves along a first auxiliary shaft trajectory and a stage where the auxiliary shaft moves along a fourth auxiliary shaft trajectory; the first auxiliary shaft trajectory is generally linear, and the fourth auxiliary shaft trajectory is generally curved; the fourth auxiliary shaft trajectory is entirely located on a side of the first auxiliary shaft trajectory away from the second wall surface.

To achieve one of the aforementioned objectives, an embodiment of the present application provides a refrigerator, comprising a storage component according to any of the aforementioned technical solutions.

Compared with the prior art, the storage component provided by the present application enhances pivoting stability by defining a stage during the door's pivoting process where the auxiliary shaft moves along a linear trajectory.

### BRIEF DESCRIPTION OF THE DRAWINGS

FIG. 1 shows a structural diagram of a storage component according to an embodiment of the present application.

FIG. 2 shows a structural diagram of the storage component in a top view according to an embodiment of the present application.

FIG. 3 shows a partial enlarged view of portion A of the storage component during opening according to an embodiment of the present application.

FIG. 4 shows a partial enlarged view of portion A of the storage component in a closed state according to an embodiment of the present application.

FIG. 5 shows a partial enlarged view of portion A of the storage component opened at a first angle according to an embodiment of the present application.

FIG. 6 shows a partial enlarged view of portion A of the storage component opened at a second angle according to an embodiment of the present application.

FIG. 7 shows a partial enlarged view of portion A of the storage component opened at a third angle according to an embodiment of the present application.

FIG. 8 shows a partial enlarged view of portion A of the storage component opened at a fourth angle according to an embodiment of the present application.

FIG. 9 shows a partial enlarged view of portion A of the storage component opened at a fifth angle according to an embodiment of the present application.

FIG. 10 shows a structural diagram showing changes of the storage component during opening according to an embodiment of the present application.

### DETAILED DESCRIPTION

The following detailed description of the present application will be made with reference to the accompanying drawings showing specific embodiments. However, these embodiments do not limit the present application, and any structural, methodological, or functional variations made by those skilled in the art based on these embodiments are included within the scope of protection of the present application.

It should be noted that the term “comprise” or any of its other variants is intended to cover a non-exclusive inclusion, such that a process, method, article, or apparatus that comprises a list of elements not only includes those elements but also includes other elements not expressly listed, or further includes elements inherent to such process, method, article, or apparatus. In addition, terms such as “first”, “second”, “third”, “fourth”, “fifth”, “sixth”, “seventh” etc. are used merely for descriptive purposes and cannot be understood to indicate or imply relative importance.

An embodiment of the present application provides a refrigerator, comprising any of a following storage component.

The refrigerator can include storage compartments of different temperature zones and refrigerator door bodies for opening and closing the storage compartments. Generally, the refrigerator is provided with a refrigeration compartment having a temperature above 0 degrees Celsius and a freezing compartment having a temperature below 0 degrees Celsius, as well as doors for opening and closing the corresponding refrigeration compartment and freezing compartment. In an embodiment, the storage component can be used to form the door and the refrigeration compartment or the freezing compartment.

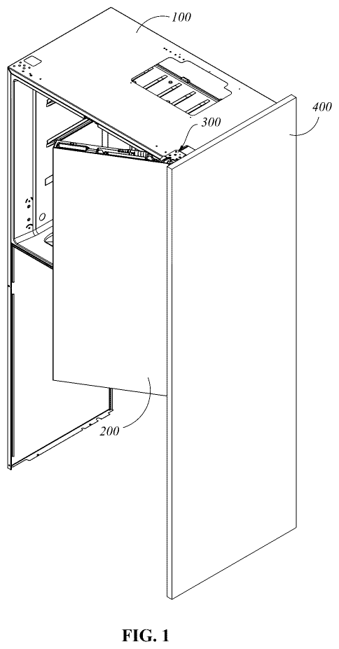

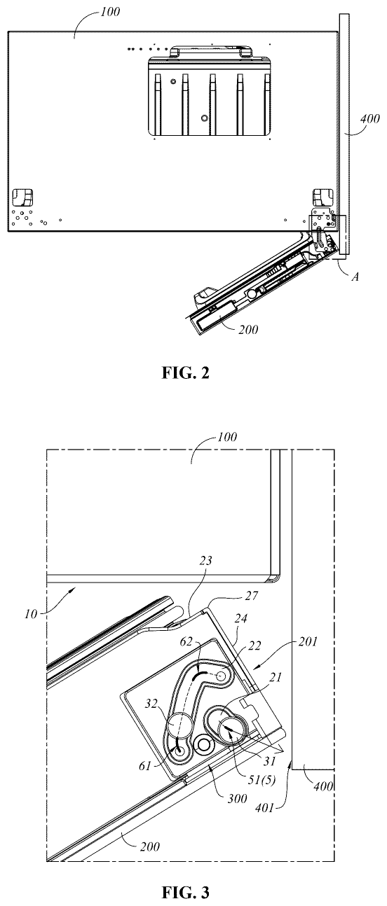

An embodiment of the present application provides a storage component, as shown in FIG. 1 and FIG. 2, comprising a housing 100, a door 200 and a hinge assembly 300.

The door 200 is pivotally connected to an opening side 10 of the housing 100 through the hinge assembly 300, configured to achieve opening and closing of an internal storage space of the housing 100 by the door 200.

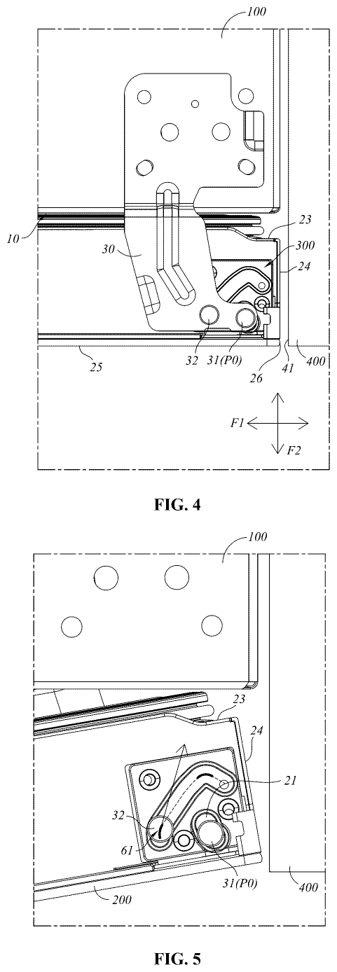

FIG. 2 is a top view of the storage component when the door 200 is opened to a certain angle, and FIG. 3 is a partial enlarged view of area A in FIG. 2. It can be understood that FIGS. 4 to 10 are also partial enlarged views corresponding to area A in FIG. 2, but indicate states when the door 200 is opened to other angles.

FIG. 3 shows an embodiment provided by the present application, wherein the hinge assembly 300 comprises a main shaft 31; the hinge assembly 300 comprises an auxiliary shaft 32; the hinge assembly 300 further comprises a main groove 21 corresponding to the main shaft 31, and an auxiliary groove 22 corresponding to the auxiliary shaft 32.

The main shaft 31 is configured to adjust the position of the door 200; the main shaft 31 is configured to drive rotation of the door 200; the main shaft 31 is configured to adjust the positional relationship between the door 200 and the housing 100; the main shaft 31 is configured to achieve translation of the door 200. During opening or closing of the door 200, one side (an opening and closing side) of the door 200 is detached from connection with the housing 100, while the other side (a pivoting side 201) maintains connection with the housing 100.

The main shaft 31 is configured to control movement of the door 200. When hinge assemblies 300 are provided at both ends of the pivoting side 201 of the door 200, the main shaft 31 can specifically be configured to control translation of the door 200; such as moving towards or away from the housing 100 side, or moving towards or away from the opening side 10. Moving towards the housing 100 means: at least the pivoting side 201 of the door 200 has a movement component towards the housing 100, or compared to the position of the door 200 when it pivots in place around a fixed axis, the position of the door 200 when it opens to the same angle with movement towards the housing 100 side is closer to the housing 100. Moving away from the housing 100 means: at least the pivoting side 201 of the door 200 has a movement component away from the housing 100, or compared to the position of the door 200 when it pivots in place around a fixed axis, the position of the door 200 when it opens to the same angle with movement away from the housing 100 side is further from the housing 100.

The auxiliary shaft 32 is configured to provide guidance for rotation of the door 200.

The auxiliary shaft 32 is configured to guide the door 200 to rotate about itself while moving, and/or to assist the main shaft 31 in achieving control over the movement of the door 200.

In an embodiment, when the door 200 is closed, relative to the auxiliary shaft 32, the main shaft 31 is arranged away from the opening side 10. In an embodiment where the storage component is arranged close to an external environment component 400, the door 200 can specifically be arranged close to the external environment component 400 through the pivoting side of the door, in this case, relative to the auxiliary shaft 32, the main shaft 31 is arranged close to the external environment component 400. The storage component is arranged at a first side 401 of the external environment component 400, wherein the first side 401 of the external environment component 400 has a space for accommodating the storage component. Relative to the opening and closing side of the door 200, the pivoting side 201 of the door 200 is closer to the external environment component 400.

In an embodiment, an extension length of the main groove 21 is shorter than an extension length of the auxiliary groove 22. Relative to the housing 100, during the process where the door 200 opens from a closed state to a maximum angle, a movement distance of the main shaft 31 is less than or equal to a movement distance of the auxiliary shaft 32.

In an embodiment, during a pivoting process of the door 200, there exists a stage where the auxiliary shaft 32 moves along an auxiliary shaft trajectory which is generally linear as a whole. This can maintain the stability of the pivoting process.

The pivoting process of the door 200 includes pivoting opening process and/or pivoting closing process. During the pivoting process, different movement states can be formed with different amplitudes, different translation amounts, or different rotation amounts, such as rotation in place, translation, and combined translation and rotation.

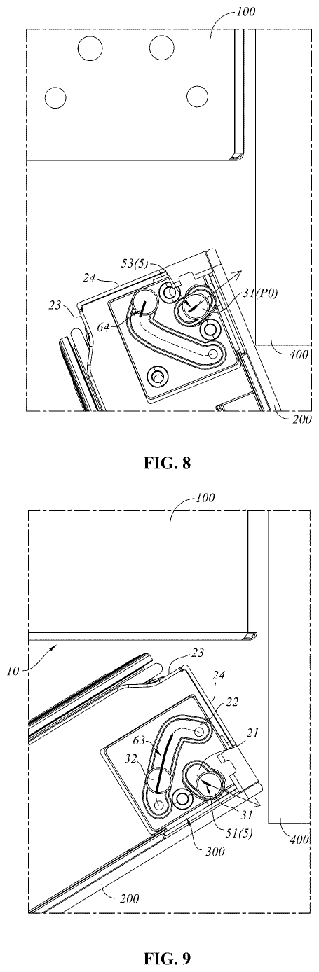

As shown in FIG. 8, during an opening process of the door 200, the main shaft 31 moves along a third main shaft trajectory 53, while the auxiliary shaft 32 moves along a first auxiliary shaft trajectory 64.

During an opening process of the door 200, there simultaneously exist a stage where the main shaft 31 moves along the third main shaft trajectory 53 and a stage where the auxiliary shaft 32 moves along the first auxiliary shaft trajectory 64.

The third main shaft trajectory 53 is generally curved, which can be a single circular arc as a whole, can be multiple circular arcs joined together, or can be generally in an irregular curved shape. The first auxiliary shaft trajectory 64 is generally linear, which can be a single straight line as a whole, or can be formed by joining multiple straight line segments.

Thus, configuring the trajectory corresponding to the guiding auxiliary shaft 32 to be linear can enhance the stability during the opening process of the door 200 while ensuring normal rotation of the door 200, and can avoid interference caused by long curved section process errors and structural aging damage problems. Since the trajectory corresponding to the main shaft 31 for driving is simultaneously configured as a curve, the main shaft 31 can achieve opening of the door 200 to an equivalent angle level with smaller position movement, and moreover, due to the smaller position movement of the main shaft 31, the pivoting and opening process of the door 200 is more stable.

In an embodiment, the arrangement of the above main shaft 31 and auxiliary shaft 32 can be in a stage after the door 200 opens to 90 degrees. That is, as shown in FIG. 7 and FIG. 8, during a process where the door 200 continues to open from 90 degrees, while the main shaft 31 moves along the third main shaft trajectory 53, the auxiliary shaft 32 moves along the first auxiliary shaft trajectory 64. This can make the opening process at large angles above 90 degrees more stable, especially ensuring more stable movement and guidance on the auxiliary shaft 64 side, even if the door 200 needs to store items, it can still stably open to large angles.

As shown in FIG. 5 and FIG. 3 or FIG. 9, during an opening process of the door 200, relative to the door 200, there successively exists a stage where the auxiliary shaft 32 moves along a third auxiliary shaft trajectory 63 and a stage where the auxiliary shaft 32 moves along a fourth auxiliary shaft trajectory 62. In an embodiment, after completing the stage of moving along the third auxiliary shaft trajectory 63, the auxiliary shaft 32 immediately enters the stage of moving along the fourth auxiliary shaft trajectory 62; in another embodiment, after completing the stage of moving along the third auxiliary shaft trajectory 63, the auxiliary shaft 32 moves along several other auxiliary shaft trajectories before entering the stage of moving along the fourth auxiliary shaft trajectory 62.

The third auxiliary shaft trajectory 63 is generally linear, which can be a single straight line as a whole, or can be formed by joining multiple straight line segments. The fourth auxiliary shaft trajectory 62 is generally curved, which can be a single circular arc as a whole, can be multiple circular arcs joined together, or can be generally in an irregular curved shape.

This can help the door 200 first generate translation amount when the auxiliary shaft 32 performs linear movement, then help the door 200 generate rotation amount when the auxiliary shaft 32 performs curved movement.

The above trajectory configuration can first make the translation amount proportion of the door 200 larger, and then make the rotation amount proportion of the door 200 larger, thereby adapting to different states of door 200 opening to adjust the proportion of rotation amount and translation amount of the door 200, which can balance the effects of interference prevention in the early stage and rapid space release and large angle opening in the middle and late stages.

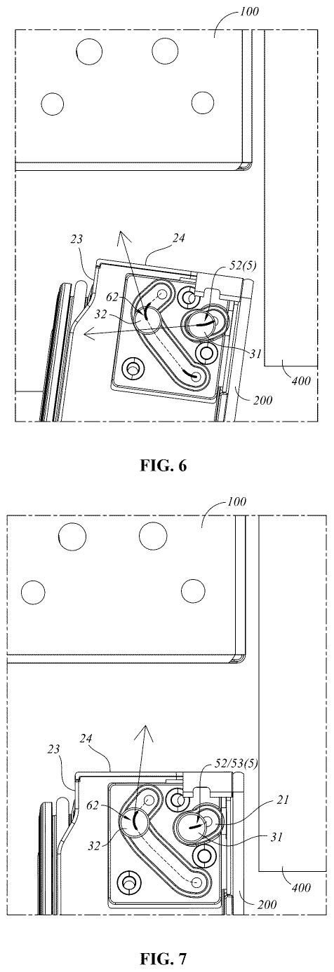

As shown in FIG. 8, FIG. 7, and FIG. 6, during a closing process of the door 200, relative to the door 200, there successively exists a stage where the auxiliary shaft 32 moves along a first auxiliary shaft trajectory 64 and a stage where the auxiliary shaft 32 moves along a fourth auxiliary shaft trajectory 62. In an embodiment, after completing the stage of moving along the first auxiliary shaft trajectory 64, the auxiliary shaft 32 immediately enters the stage of moving along the fourth auxiliary shaft trajectory 62; in another embodiment, after completing the stage of moving along the first auxiliary shaft trajectory 64, the auxiliary shaft 32 moves along several other auxiliary shaft trajectories before entering the stage of moving along the fourth auxiliary shaft trajectory 62.

The first auxiliary shaft trajectory 64 is generally linear, which can be a single straight line as a whole, or can be formed by joining multiple straight line segments. The fourth auxiliary shaft trajectory 62 is generally curved, which can be a single circular arc as a whole, can be multiple circular arcs joined together, or can be generally in an irregular curved shape.

Thus, during the closing process, this can help the door 200 first generate translation amount when the auxiliary shaft 32 performs linear movement, then help the door 200 generate rotation amount when the auxiliary shaft 32 performs curved movement.

The above trajectory configuration allows, during a closing process, the translation amount proportion of the door 200 to be larger first, and then the rotation amount proportion of the door 200 to be larger, thereby adapting to different states of door 200 closing to adjust the proportion of rotation amount and translation amount of the door 200, which can balance the effects of interference prevention in the early closing stage and rapid closing rotation of the access opening side of the housing in the middle and late stages.

In an embodiment, as shown in FIG. 4 and FIG. 5, the storage component is arranged at a side of an external environment component 400, and the door 200 comprises a second wall surface 24.

When the door 200 closes the opening side 10 of the housing 100, the hinge assembly 300 is close to a first side face 41 of the external environment component 400; the second wall surface 24 is close to the first side face 41, and the second wall surface 24 is parallel to the first side face 41. This can define the relationships between various wall surfaces on the door 200.

The door 200 comprises a first wall surface 23 and a second wall surface 24 perpendicular to each other. The first wall surface 23 is close to a plane where the opening side 10 is located; the second wall surface 23 is generally parallel to a plane where the opening side 10 is located.

The external environment component 400 can be any part that might interfere with the pivoting opening of the door 200, such as, in a scenario where the storage component is arranged vertically, the external environment component 400 can be a wall, cabinet inner wall, etc. close to the storage component; or, in a scenario where the storage component is arranged horizontally, the external environment component 400 can be a floor, kickboard or cabinet inner wall, etc.

The first side face 41 can be a side face of the external environment component 400 that is close to the housing 100 and/or the door 200. The parallel relationship includes at least two types: strictly parallel and approximately parallel (angle less than a set range), whether strictly parallel depends on the shape and flatness of the door 200, the shape and flatness of the opening side 10, and the shape and flatness of the first side face 41. The plane where the opening side 10 is located refers to the housing 100 plane that users face when taking items from the opening side 10, in the top view shown in FIGS. 3 to 10, the plane where the opening side 10 is located can refer to a plane extending horizontally at the opening side 10.

When the door 200 closes the opening side 10 of the housing 100, the first wall surface 23 is close to and parallel to a plane where the opening side 10 is located. This can define the relationships between various wall surfaces on the door 200. Although the first wall surface 23 is viewed in the figures as a wall surface on the main body of the door 200 excluding a door seal structure that is close to and parallel to a plane where the opening side 10 is located, in some embodiments, the door 200 can be defined as a component assembly including the door seal, thus making the first wall surface correspond to a part of the door seal.

A main shaft trajectory 5 can include a third main shaft trajectory 53, as shown in FIG. 8 in conjunction with FIG. 7.

During an opening process of the door 200 and movement of the main shaft 31 along the third main shaft trajectory 53, relative to the door 200, there exists a stage where the main shaft 31 moves simultaneously closer to the second wall surface 24 and away from the first wall surface 23. In embodiments where the main shaft 31 is fixed to the housing 100, based on the principle of relative motion, the second wall surface 24 can move in a direction closer to the main shaft 31, and the first wall surface 23 can move in a direction away from the main shaft 31. This can achieve control over the movement direction of the wall surfaces and their associated edges.

For ease of description, a direction towards the external environment component 400 can be defined as “outward”, a direction away from the external environment component 400 can be defined as “inward”, a direction towards the housing 100 can be defined as “backward”, and a direction away from the housing 100 can be defined as “forward”.

On one hand, when a perpendicular line from a center point of the main shaft 31 to the second wall surface 24 has a component extending parallel to the first side face of the external environment component 400 (that is, having a component extending vertically or longitudinally as shown in FIG. 8), since the second wall surface 24 is close to the main shaft 31 at this time, it can be considered that the second wall surface 24 has a forward movement component. Thus, both the second wall surface 24 and edges formed by intersection of the second wall surface 24 and other wall surfaces of the door 200 (such as a first side edge and second side edge mentioned later) have an inward movement component, which can prevent interference or damage caused by edges or wall surfaces pressing against the housing 100 when the door 200 opens to a larger angle.

It can be seen that the change in the perpendicular line from the center point of the main shaft 31 to the second wall surface 24 can determine the movement of the second wall surface 24 and its associated edges. For example, if the length of the perpendicular line from the center point of the main shaft 31 to the second wall surface 24 increases, it indicates that, at least in the extending direction of this perpendicular line, the main shaft 31 and the second wall surface 24 have relative movement away from each other. Also, if the length decreases, it indicates they have relative movement towards each other. Based on this, the perpendicular line from the center point of the main shaft 31 to the second wall surface 24 can be viewed as a directional line segment, that is, this perpendicular line can be viewed as a vector. Therefore, this perpendicular line from the center point of the main shaft 31 to the second wall surface 24 is defined as a second vector perpendicular line in the following text.

In an embodiment, a perpendicular line from the center point of the main shaft 31 to the first wall surface 23 can be defined as a first vector perpendicular line.

When the first vector perpendicular line has a component extending perpendicular to the first side face of the external environment component 400 (that is, having a component extending horizontally or transversely as shown in FIG. 9), since this first vector perpendicular line points in a direction away from the main shaft 31, it can be considered that the first wall surface 23 has an inward movement component. Thus, both the first wall surface 23 and edges formed by intersection of the first wall surface 23 and other wall surfaces of the door (such as a second side edge formed by the intersection of the first wall surface 23 and the second wall surface 24) have an inward movement component, which can assist in opening to a larger angle while preventing interference with the external environment component 400 and other components.

Looking at the combination of other vector perpendicular lines, the second wall surface 24 moves forward and outward as a whole, while the first wall surface 23 moves inward and forward as a whole.

Correspondingly, during a closing process of the door 200, relative to the door 200, when the main shaft 31 moves along the third main shaft trajectory 53, the main shaft 31 simultaneously moves away from the second wall surface 24 and closer to the first wall surface 23. The second wall surface 24 moves backward and inward as a whole, while the first wall surface 23 moves outward and backward as a whole. Thus, the door 200 can quickly recover from a large-angle state. Particularly, both the second wall surface 24 and the first wall surface 23 move backward, which can control a free end of the door 200 from protruding excessively during a closing process through the movement of a rotating end surface, and the two perpendicular wall surfaces move in different directions in the “inward” and “outward” directions, enabling the door to quickly rotate and close.

As shown in FIG. 9, FIG. 6 and FIG. 7, the fourth auxiliary shaft trajectory 62 is entirely located on a side of the third auxiliary shaft trajectory 63 closer to the second wall surface 24. Thus, during the opening process, the auxiliary shaft 32 first moves along the linear third auxiliary shaft trajectory 63, then maintains a curved movement continuously approaching the second wall surface 24, which can deepen the degree of door opening and improve the smoothness of shaft-groove cooperation, avoiding structural aging and damage caused by interference.

In an embodiment, during the transition from moving along the third auxiliary shaft trajectory 63 to moving along the fourth auxiliary shaft trajectory 62, an angle between a movement direction of the auxiliary shaft 32 and the second wall surface 24 gradually increases from an acute angle. Thus, the transition between the third auxiliary shaft trajectory 63 and the fourth auxiliary shaft trajectory 62 is more continuous and smooth, with no sudden angle changes during trajectory switching, and due to the gradual increase from an acute angle, the process of deepening the rotation opening degree of the door 200 is more stable and can assist in subsequently opening to a larger angle.

As shown in FIG. 8, FIG. 7, and FIG. 6, the fourth auxiliary shaft trajectory 62 is entirely located on a side of the first auxiliary shaft trajectory 64 away from the second wall surface 24. Thus, during a closing process, the auxiliary shaft 32 first moves along the linear first auxiliary shaft trajectory 64, then maintains a curved movement continuously moving away from the second wall surface 24, which can increase the closing amplitude and improve the smoothness of shaft-groove cooperation, avoiding structural aging and damage caused by interference.

In an embodiment, during the transition from moving along the first auxiliary shaft trajectory 64 to moving along the fourth auxiliary shaft trajectory 62, an angle between a movement direction of the auxiliary shaft 32 and the second wall surface 24 gradually increases from an acute angle. Thus, the transition between the first auxiliary shaft trajectory 64 and the fourth auxiliary shaft trajectory 62 is more continuous and smooth, with no sudden angle changes during trajectory switching, and due to the gradual increase from an acute angle, the process of deepening the rotation opening degree of the door 200 is more stable and can assist in subsequently opening to a larger angle.

During an opening process of the door 200 and movement of the auxiliary shaft 32 along a first auxiliary shaft trajectory 64, relative to the door 200, there exists a stage where the auxiliary shaft 32 moves simultaneously closer to the second wall surface 24 and away from the first wall surface 23. Thus, as the auxiliary shaft 32 approaches the second wall surface 24, it can deepen the rotation amplitude of the door 200, achieving the effect of large-angle opening; it can control and deepen the rotation amplitude of the door 200 during the middle and late stages of rotational opening (for example, where the door 200 opens to more than 90 degrees), achieving large-angle opening of the door 200.

In embodiments where the first auxiliary shaft trajectory 64 is generally linear, it can make the movement of the door 200 more stable during the large-angle opening process.

In embodiments where the auxiliary shaft 32 extends towards a midpoint of a side edge formed by the second wall surface 24 and an upper surface of the door 200, the auxiliary shaft 32 effectively moves towards a mass center plane of the door 200 (a plane parallel to the front wall of the door 200 passing through a mass center of the door 200), which can make the movement process and suspension process of the door 200 more stable.

Referring to FIG. 4, if the door 200 is defined to include a third wall surface 25, when the door 200 closes the opening side 10 of the housing 100, the third wall surface 25 is away from and parallel to a plane where the opening side 10 is located. If a first side edge 26 is defined as formed by the intersection of the third wall surface 25 and the second wall surface 24, then during the opening process of the door 200, the main shaft 31 moves along the third main shaft trajectory 53 towards a direction closer to the first side edge 26, and the auxiliary shaft 32 moves along the first auxiliary shaft trajectory 64 towards a direction closer to the first side edge 26, thereby achieving both stability and large-angle opening during the movement of the door 200.

Correspondingly, during a closing process of the door 200, during movement of the auxiliary shaft 32 along the first auxiliary shaft trajectory 64, relative to the door 200, there exists a stage where the auxiliary shaft 32 moves simultaneously away from the second wall surface 24 and closer to the first wall surface 23. Thus, it can close the door 200 stably and quickly.

In an embodiment, the storage component is arranged at a side of an external environment component 400. The storage component is arranged at a first side 401 of the external environment component 400, where the first side 401 of the external environment component 400 has a space for accommodating the storage component. The main shaft 31 is fixed to the housing 100, and the main groove 21 is fixed to the door 200. As shown in FIG. 4 and FIG. 5, the main shaft 31 can specifically be fixed to the housing 100 through a hinge plate 30. When the door 200 closes the opening side 10 of the housing 100, the hinge assembly 300 is arranged close to the external environment component 400. The storage component is arranged at the first side 401 of the external environment component 400, where the first side 401 of the external environment component 400 has a space for accommodating the storage component. Relative to the opening and closing side of the door, the pivoting side 201 of the door 200 is closer to the external environment component 400.

In this embodiment, a side close to the external environment component 400 can be defined as the pivoting side 201 of the door 200. The pivoting side 201 of the door 200 may interfere with the external environment component 400 during the opening process.

The main shaft 31 can be fixed to the door 200 or integrally formed with the door 200; correspondingly, the main groove 21 can be fixed to the housing 100, or the positions of the shaft and groove can be exchanged by forming the main groove 21 on the hinge plate 30.

The auxiliary shaft 32 can be fixed to the housing 100, and the auxiliary groove 22 can be fixed to the door 200; similar to the main shaft 31, the auxiliary shaft 32 can be fixed to the housing 100 through the hinge plate 30.

During an opening process of the door 200, as shown in FIG. 9, relative to the door 200, the main shaft 31 has a movement component in a direction towards a side close to the external environment component 400; based on the principle of relative motion, the door 200 correspondingly has a movement component in the direction away from the external environment component 400. During an opening process of the door 200, relative to the door 200, the main shaft 31 moves closer to the external environment component 400; based on the principle of relative motion, the door 200 moves away from the external environment component 400.

Thus, it can prevent interference between the door 200 and the external environment component 400. When the main shaft 31 is arranged on the door 200, based on the above technical effect, relative to the housing 100, the main shaft 31 may have a movement component in a direction away from the external environment component 400.

At this time, there is no restriction on the arranging position and movement direction of the auxiliary shaft 32; nor is it required that the main shaft 31 must move in a direction perpendicular to the external environment component 400 (having a movement component away from/towards the external environment component 400 is sufficient).

In an embodiment, as shown in FIG. 8 in conjunction with FIG. 4, the storage component is arranged at a side of the external environment component 400. When the door 200 closes the opening side 10 of the housing 100, the hinge assembly 300 is close to the external environment component 400. Thus, this defines the pivoting side of the door 200 that achieves rotation through the hinge assembly 300.

During movement of the auxiliary shaft 32 along the first auxiliary shaft trajectory 64, there exists a stage where the door 200 moves in a direction away from the external environment component 400. Thus, it can help the door 200 avoid interference with the external environment component 400 and build a positional foundation for large-angle opening of the door 200.

In an embodiment, during movement of the auxiliary shaft 32 along the first auxiliary shaft trajectory 64, there exists a stage where the door 200 moves simultaneously away from the external environment component 400 and away from the housing 100. Thus, it can not only achieve both large-angle opening and interference prevention effects but also prevent a portion of the door 200 (especially the first side edge 26) from pressing against the housing 100.

The present application is not limited to the door 200 always having movement in the above direction during movement along the first auxiliary shaft trajectory 64. Before the above movement stage, as the auxiliary shaft 32 moves along the first auxiliary shaft trajectory 64, the door 200 may include movements in other directions, and/or after the above movement stage, as the auxiliary shaft 32 moves along the first auxiliary shaft trajectory 64, the door may include movements in other directions.

Besides the above movements, the door 200 can undergo rotation, which is also not restricted by the present application.

In an embodiment, as shown in FIG. 8 in conjunction with FIG. 4, the storage component is arranged at a side of the external environment component 400, and the door 200 includes a second wall surface 24. When the door 200 closes the opening side 10 of the housing 100, the hinge assembly 300 is close to a first side face 41 of the external environment component 400, the second wall surface 24 is close to the first side face 41, and the second wall surface 24 is parallel to the first side face 41. Thus, this can define the position of the second wall surface 24 on the door 200.

The main shaft trajectory 5 may include at least a curved section. The curved section of the main shaft trajectory 5 protrudes towards a side away from the second wall surface 24.

This curved section can be a single circular arc, multiple circular arcs joined together, or can be an arc-shaped curve.

The arc shape can be strictly arc-shaped, or can be approximately arc-shaped within a certain error range of deformation. This will not be repeated in the following text.

The protruding direction of the above curved section can be understood as: an intersection point of perpendicular lines to any two tangent lines on the curved section is located on a side of the curved section closer to the second wall surface 24. The protruding direction of the above curved section can be understood as: a point farthest from the second wall surface 24 on the curved section is located at a position other than the endpoints on the curved section. The protruding direction of the above curved section can be understood as: a tangent point of a tangent line parallel to a line connecting the two endpoints of the curved section on the curved section are located on a side away from the second wall surface 24 relative to the line connecting the two endpoints of the curved section. Thus, the curved section can not only achieve smooth guidance for the movement of the door 200, but also reduce the restriction on the shape of the auxiliary groove 22 by the rotation of the door 200, allowing the auxiliary groove 22 to be configured in a shape that makes the door 200 move more stably; with the curved section protruding in the direction away from the second wall surface 24, based on the principle of relative motion, it can make the second wall surface 24, as a rotating end surface, first have a movement component away from the main shaft 31, then move towards the main shaft, and facilitate the design of movement trajectories for various edges of the second wall surface 24, which can improve interference prevention and avoid affecting access to items stored in the storage component.

The third main shaft trajectory 53 protrudes towards a side away from the second wall surface 24. The protruding direction of the above third main shaft trajectory 53 can be understood as: an intersection point of perpendicular lines to any two tangent lines on the third main shaft trajectory 53 is located on a side of the third main shaft trajectory 53 closer to the second wall surface 24. The protruding direction of the above third main shaft trajectory 53 can be understood as: a point farthest from the second wall surface 24 on the third main shaft trajectory 53 is located at a position other than the endpoints on the third main shaft trajectory 53. The protruding direction of the above third main shaft trajectory 53 can be understood as: a tangent point of a tangent line parallel to a line connecting the two endpoints of the third main shaft trajectory on the third main shaft trajectory 53 are located on a side away from the second wall surface 24 relative to the line connecting the two endpoints of the third main shaft trajectory. Thus, the third main shaft trajectory 53 can not only achieve smooth guidance for the movement of the door 200, but also reduce the restriction on the shape of the auxiliary groove 22 by the rotation of the door 200, allowing the auxiliary groove 22 to be configured in a shape that makes the door 200 move more stably; with the third main shaft trajectory 53 protruding in the direction away from the second wall surface 24, based on the principle of relative motion, it can make the second wall surface 24, as a rotating end surface, first have a movement component away from the main shaft 31, then move towards the main shaft, and facilitate the design of movement trajectories for various edges of the second wall surface 24, which can improve interference prevention and avoid affecting access to items stored in the storage component.

The main shaft trajectory 5 is generally in a shape of an elliptical arc. Thus, the main shaft trajectory 5 has a longer extension length, making the effect of preventing interference with the door 200 better. On one hand, the main shaft trajectory 5 can be configured as a standard elliptical arc, with a line connecting two endpoints of the main shaft trajectory 5 parallel to a major axis of an elliptical arc the main shaft trajectory 5 belongs to, meaning the main shaft trajectory 5 is overall an axially symmetric figure with a certain extension length; on the other hand, the main shaft trajectory 5 can be configured as a curve formed by joining multiple circular arcs and/or elliptical arcs and/or linear lines, and the present application does not restrict its joining method.

The elliptical arc shape can be strictly elliptical arc-shaped, or can be approximately elliptical arc-shaped within a certain error range of deformation. This will not be repeated in the following text.

The third main shaft trajectory 53 is generally in a shape of an elliptical arc. Thus, the third main shaft trajectory 53 has a longer extension length, making the effect of preventing interference with the door 200 better. On one hand, the third main shaft trajectory 53 can be configured as a standard elliptical arc, with a line connecting two endpoints of the third main shaft trajectory 53 parallel to a major axis of an elliptical arc the third main shaft trajectory 53 belongs to, meaning the third main shaft trajectory 53 is overall an axially symmetric figure with a certain extension length; on the other hand, the third main shaft trajectory 53 can be configured as a curve formed by joining multiple circular arcs and/or elliptical arcs and/or linear lines, and the present application does not restrict its joining method.

The third main shaft trajectory 53 can be part of the main shaft trajectory 5.

The main shaft trajectory 5 as a whole can be configured to have all the properties possessed by the above third main shaft trajectory 53.

Different trajectory segments in the main shaft trajectory 5 transition smoothly.

In an embodiment, as shown in FIG. 9 and FIG. 4, during an opening process of the door 200, there exists a stage where the main shaft 31 moves along a first main shaft trajectory 51.

The main shaft trajectory 5 may include a first main shaft trajectory 51. Relative to the door 200, when the main shaft 31 moves along the first main shaft trajectory 51, the main shaft 31 moves simultaneously closer to the second wall surface 24 and away from the first wall surface 23. In embodiments where the main shaft 31 is fixed to the housing 100, based on the principle of relative motion, the second wall surface 24 can move in a direction closer to the main shaft 31, and the first wall surface 23 can move in a direction away from the main shaft 31. Thus, this can achieve control over the movement direction of the wall surfaces and their associated edges.

On one hand, when the second vector perpendicular line from a center point of the main shaft 31 to the second wall surface 24 has a component extending perpendicular to the first side face of the external environment component 400 (that is, having a component extending horizontally or transversely as shown in FIG. 3 and FIG. 9), it can be considered that the second wall surface 24 has an inward movement component. Thus, both the second wall surface 24 and edges formed by intersection of the second wall surface 24 and other wall surfaces of the door (such as a first side edge and second side edge mentioned later) have an inward movement component, which can effectively mitigate interference phenomena relative to the external environment component 400.

On the other hand, when the first vector perpendicular line from the first wall surface 23 to a center point of the main shaft 31 has a component extending parallel to the first side face of the external environment component 400 (that is, having a component extending vertically or longitudinally as shown in FIG. 3 and FIG. 9), since the first vector perpendicular line points in a direction away from the main shaft 31, it can be considered that the first wall surface 23 has a backward movement component. Thus, both the first wall surface 23 and edges formed by intersection of the first wall surface 23 and other wall surfaces of the door (such as a second side edge formed by the intersection of the first wall surface 23 and the second wall surface 24) have a backward movement component, which can enhance the integration of the door 200 with the housing 100, preventing the door 200 from excessively separating from the housing 100. If there was a stage of rotation in place before this (for example, where the door 200 rotates around the main shaft 31 as a rotation axis, or the auxiliary shaft moves along a second auxiliary shaft trajectory 61), then due to having opened to a certain rotation angle, the first wall surface 23 and related edges will not interfere with or press against the housing 100.

In some embodiments, the direction towards the housing 100 can be defined as “backward”, and the direction away from the housing 100 can be defined as “forward”, with reference to the refrigerator's usage state.

Looking at the combination of other vector perpendicular lines, the second wall surface 24 moves inward and forward as a whole (forward being towards a direction away from the opening side 10 of the housing 100, which can be along a direction away from the opening side 10 on the first side face 41), while the first wall surface 23 moves inward and backward as a whole.

Correspondingly, during a closing process of the door 200, relative to the door 200, when the main shaft 31 moves along the first main shaft trajectory 51, the main shaft 31 moves simultaneously away from the second wall surface 24 and closer to the first wall surface 23. The second wall surface 24 moves outward and backward as a whole, while the first wall surface 23 moves outward and forward as a whole. Thus, the first wall surface 23 can quickly return to position outward and move forward to avoid pressing against the housing 100; the second wall surface 24 returns to position outward as a whole and moves backward to prevent unnecessary gaps between the door 200 and the housing 100.

In an embodiment, as shown in FIG. 6 and FIG. 4, during an opening process of the door 200, there exists a stage where the main shaft 31 moves along a second main shaft trajectory 52.

The main shaft trajectory 5 may include the second main shaft trajectory 52. Relative to the door 200, when the main shaft 31 moves along the second main shaft trajectory 52, the main shaft 31 moves simultaneously away from the second wall surface 24 and closer to the first wall surface 23. In embodiments where the main shaft 31 is fixed to the housing 100, based on the principle of relative motion, the second wall surface 24 can move in a direction away from the main shaft 31, and the first wall surface 23 can move in a direction closer to the main shaft 31. Thus, this can achieve control over the movement direction of the wall surfaces and their associated edges.

On one hand, when the second vector perpendicular line from a center point of the main shaft 31 to the second wall surface 24 has a component extending parallel to the first side face of the external environment component 400 (that is, having a component extending vertically or longitudinally as shown in FIG. 9), since this second vector perpendicular line points in a direction away from the main shaft 31, it can be considered that the second wall surface 24 has a backward movement component. Thus, both the second wall surface 24 and edges formed by intersection of the second wall surface 24 and other wall surfaces of the door (such as a first side edge and second side edge mentioned later) have a backward movement component, allowing the door 200 to rotate open to a larger angle while enhancing integration with the housing 100, and also helping prevent interference with the external environment component 400.

On the other hand, when the first vector perpendicular line from the first wall surface 23 to a center point of the main shaft 31 has a component extending perpendicular to the first side face of the external environment component 400 (that is, having a component extending horizontally or transversely as shown in FIG. 9), since the first vector perpendicular line points in a direction closer to the main shaft 31, it can be considered that the first wall surface 23 has an outward movement component. Thus, both the first wall surface 23 and edges formed by intersection of the first wall surface 23 and other wall surfaces of the door (such as a second side edge formed by the intersection of the first wall surface 23 and the second wall surface 24) have an outward movement component, allowing the door 200 to rotate open to a larger angle while preventing interference or pressure between the door 200 and the housing 100.

Looking at a combination of other vector perpendicular lines, the second wall surface 24 moves outward and backward as a whole, while the first wall surface 23 moves outward and forward as a whole.

Correspondingly, during a closing process of the door 200, relative to the door 200, when the main shaft 31 moves along the second main shaft trajectory 52, the main shaft 31 moves simultaneously closer to the second wall surface 24 and away from the first wall surface 23. The second wall surface 24 moves inward and forward as a whole, while the first wall surface 23 moves inward and backward as a whole. Thus, both the second wall surface 24 and the second wall surface 23 can move inward as a whole, allowing the door 200 to achieve quick inward movement and recovery. Because the second wall surface 24 is located on a side of the door 200 relatively closer to the external environment component 400, a forward movement of the second wall surface 24 can avoid interference with the external environment component 400, and based on a backward movement of the first wall surface 23, it can quickly drive the second wall surface 24 to pivot and close.

During an opening process of the door 200, there successively exists a stage where the main shaft 31 moves along the first main shaft trajectory 51, a stage where the main shaft 31 moves along the second main shaft trajectory 52, and a stage where the main shaft 31 moves along the third main shaft trajectory 53. That is, the main shaft 31 changes state in the order shown in FIG. 4, FIG. 5, FIG. 3 or FIG. 9, FIG. 6, FIG. 7, FIG. 8. The main shaft 31 can start from the middle of the main groove 21 shown in FIG. 4 and FIG. 5, first move to an end of the main groove 21 closer to the second wall surface 24 and away from the first wall surface 23 as shown in FIG. 3 or FIG. 9 (or move to an end of the main shaft trajectory 5), then move to an end of the main groove 21 away from the second wall surface 24 and closer to the first wall surface 23 as shown in FIG. 7 (or move to another end of the main shaft trajectory 5), and finally return to the middle of the main groove 21 as shown in FIG. 8.

The shaft moving to the end of the groove does not necessarily mean that the shaft surface abuts against the groove inner wall. The present application does not exclude leaving a gap between the shaft surface and the groove inner wall at the end of the groove when the shaft moves to a limit position near the end of the groove, to balance tolerances and prevent structural damage.

Correspondingly, during a closing process of the door 200, the main shaft 31 moves successively along the third main shaft trajectory 53, the second main shaft trajectory 52, and the first main shaft trajectory 51. That is, the main shaft 31 changes state in the order shown in FIG. 8, FIG. 7, FIG. 6, FIG. 3 or FIG. 9, FIG. 5, FIG. 4. The main shaft 31 starts from the middle of the main groove 21, first moves to an end of the main groove 21 away from the second wall surface 24 and closer to the first wall surface 23, then moves to an end of the main groove 21 closer to the second wall surface 24 and away from the first wall surface 23, and finally returns to the middle of the main groove 21.

A sum of lengths of the first main shaft trajectory 51 and the third main shaft trajectory 53 equals to a length of the second main shaft trajectory 52. Thus, this not only makes a reciprocating path of the main shaft 31 in the main groove 21 consistent but also maintains consistency between an initial position PO and a final position of the main shaft 31 throughout the movement of the main shaft 31; this not only can shorten the length of the main groove 21, helping reduce the thickness of the door 200, but also can maintain the stability of the movement of the door 200, and may even reduce the number of suspension devices in the shaft groove.

In an embodiment, as shown in FIG. 4 and FIG. 5, there exists a stage where the auxiliary shaft 32 moves along the second auxiliary shaft trajectory 61.

During an opening process of the door 200 and movement of the auxiliary shaft 32 along a second auxiliary shaft trajectory 61, the main shaft 31 rotates about itself, and the door 200 rotates in place with the main shaft 31 as a rotation axis.

During this process, the main shaft 31 remains at the initial position PO relative to the main groove 21.

In an embodiment, as shown in FIG. 3 and FIG. 9, there exists a stage where the auxiliary shaft 32 moves along the third auxiliary shaft trajectory 63.

During an opening process of the door 200 and movement of the auxiliary shaft 32 along the third auxiliary shaft trajectory 63, relative to the door 200, there exists a stage where the auxiliary shaft 32 moves simultaneously closer to the second wall surface 24 and closer to the first wall surface 23. Thus, this can help achieve stability in a rotational opening process of the door 200, and when the distance between the main shaft 31 and the auxiliary shaft 32 is fixed, it can control the main shaft 31 to move in a direction away from the auxiliary shaft 32, thereby controlling the effect of the main shaft 31 moving along the first main shaft trajectory 51.

During movement of the auxiliary shaft 32 along the third auxiliary shaft trajectory 63, there exists a stage where the door 200 moves in a direction away from the external environment component 400. Thus, this can not only complete the guidance of the movement of the door 200 through the auxiliary shaft 32 but also achieve movement of the door 200 away from the external environment component 400, effectively achieving interference prevention.

As shown in FIG. 8, FIG. 7, and FIG. 6, in an embodiment, during an opening process of the door 200 and movement of the auxiliary shaft 32 along the first auxiliary shaft trajectory 64, there exists a stage where the door 200 moves in a direction away from the external environment component 400. Thus, this can not only complete the guidance of the movement of the door 200 through the auxiliary shaft 32, but since the first auxiliary shaft trajectory 64 occurs before the fourth auxiliary shaft trajectory 62 during the closing process, the first auxiliary shaft trajectory 64 occurs at a later time stage during the opening process, and through moving outward towards the external environment component 400, it can allow the door 200 to open to a larger angle, facilitating user access to items stored in the storage component.

The present application does not limit the door 200 to moving away from the external environment component 400 throughout the entire process when the auxiliary shaft 32 moves along the third auxiliary shaft trajectory 63, there can be movements of the door 200 in other directions. The present application also does not limit the door 200 to only having translation during this process, the door 200 can undergo pivotal opening during this process.

Correspondingly, during a closing process of the door 200, during movement of the auxiliary shaft 32 along the first auxiliary shaft trajectory 64, there exists a stage where the door 200 moves in a direction closer to the external environment component 400. Thus, the pivoting side of the door 200 returns to position, and based on the leverage principle, it can make a free end of the door 200 rotate back to a smaller angle more quickly, achieving rapid closure of the door 200.

Specifically, in a state shown in FIG. 8, during a closing process of the door 200, the main shaft 31 moves in a direction away from the external environment component 400, and based on the principle of relative motion, the door 200 moves closer to the external environment component 400.

In an embodiment, as shown in FIG. 3, FIG. 9, and FIG. 6, during movement of the auxiliary shaft 32 relative to the door 200 along the third auxiliary shaft trajectory 63, the door 200 first moves in a direction away from the external environment component 400, then moves in a direction closer to the external environment component 400. Thus, this can control the door 200 to move away from the external environment component 400 in an early stage of rotational opening process to prevent interference of the door 200, and can move towards the external environment component 400 in middle and late stages of rotational opening process, releasing the opening for items accessing of the storage component, preventing interference with internal structures such as shelves and other storage components, and facilitating the door 200 to open to a larger angle.

Specifically, in a state shown in FIG. 3 or FIG. 9, relative to the door 200, the main shaft 31 moves in a direction closer to the external environment component 400, and based on the principle of relative motion, the door 200 moves away from the external environment component 400. In a state shown in FIG. 9 in conjunction with FIG. 6, relative to the door 200, after completing the stage of moving towards the external environment component 400, the main shaft 31 reverses its movement direction and there exists a stage where the main shaft 31 moves in a direction away from the external environment component 400, and based on the principle of relative motion, the door 200 moves closer to the housing 100.

Thus, when the auxiliary shaft 32 moves along the third auxiliary shaft trajectory 63, the main shaft 31 first moves along the first main shaft trajectory 51, then moves along the second main shaft trajectory 52 (refer to FIG. 6, before a state shown in FIG. 6). When the auxiliary shaft 32 moves along the third auxiliary shaft trajectory 63, the door 200 first moves simultaneously away from the external environment component 400 and closer to the housing 100, then moves simultaneously closer to the external environment component 400 and away from the housing 100, and finally moves simultaneously closer to the external environment component 400 and closer to the housing 100.

When the main shaft 31 moves along the first main shaft trajectory 51, relative to the housing 100 and the external environment component 400, the corresponding portion of the main groove 21 at the main shaft 31 consistently moves in a direction away from the external environment component 400 and closer to the housing 100.

When the main shaft 31 moves along the second main shaft trajectory 52, relative to the housing 100 and the external environment component 400, the corresponding portion of the main groove 21 at the main shaft 31 first moves in a direction closer to the external environment component 400 and away from the housing 100, until the movement direction of the corresponding portion in the main groove 21 is perpendicular to the first side face of the external environment component 400, and then, the corresponding portion of the main groove 21 at the main shaft 31 continues to move in a direction closer to the external environment component 400 and closer to the housing 100, until the auxiliary shaft 32 reaches an end of the third auxiliary shaft trajectory 63; when the end of the third auxiliary shaft trajectory 63 coincides with a starting point of the fourth auxiliary shaft trajectory 62, reference can be made to FIG. 9.

In an embodiment, as shown in FIG. 6 and FIG. 7, there exists a stage where the auxiliary shaft 32 moves along the fourth auxiliary shaft trajectory 62.

During an opening process of the door 200 and movement of the auxiliary shaft 32 along the fourth auxiliary shaft trajectory 62, relative to the door 200, there exists a stage where the auxiliary shaft 32 moves simultaneously closer to the second wall surface 24 and away from the first wall surface 23. Thus, after the door 200 opens to a certain angle, the auxiliary shaft 32 can assist the door 200 in deepening the rotation opening angle of the door 200, meeting users' needs to quickly release storage space thereafter; during the process of the door 200 opening to a certain angle, when the distance between the main shaft 31 and the auxiliary shaft 32 is fixed, the auxiliary shaft 32 can assist the door 200 in moving towards a side closer to the external environment component 400 while rotating, thus quickly releasing the access opening side of the housing, expanding the width of the access opening side, and meeting users' needs.

In embodiments where the second auxiliary shaft trajectory 61 is curved, the process of the door 200 continuing to pivot open is smoother.

Correspondingly, during a closing process of the door 200, during movement of the auxiliary shaft 32 along the fourth auxiliary shaft trajectory 62, relative to the door 200, there exists a stage where the auxiliary shaft 32 moves simultaneously away from the second wall surface 24 and away from the first wall surface 23. Thus, this can smoothly and quickly close the door 200.

The present application is not limited to the auxiliary shaft 32 always having movement in the above direction during movement along the fourth auxiliary shaft trajectory 62. Before the above movement stage, the auxiliary shaft 32 may include movements in other directions, and/or after the above movement stage, the auxiliary shaft 32 may include movements in other directions. As shown in FIG. 6 to FIG. 8, in an embodiment provided by the present application, during an opening process of the door 200 and movement of the auxiliary shaft 32 along the fourth auxiliary shaft trajectory 62, relative to the door 200, the auxiliary shaft 32 first moves simultaneously closer to the first wall surface 23 and closer to the second wall surface 24, then moves simultaneously closer to the second wall surface 24 and away from the first wall surface 23. Thus, this can reduce rotation amount of the door or reduce the ratio of rotation amount of the door to translation amount of the door, helping avoid interference and enhance the stability of the movement of the door 200.

Correspondingly, during a closing process of the door 200, during movement of the auxiliary shaft 32 along the fourth auxiliary shaft trajectory 62, relative to the door 200, the auxiliary shaft 32 first moves simultaneously away from the second wall surface 24 and closer to the first wall surface 23, then moves simultaneously away from the second wall surface 24 and away from the first wall surface 23. Thus, this can initially shorten the perpendicular distance between the auxiliary shaft 32 and the first wall surface 23, controlling the door 220 from the rotating end surface side and quickly recovering it from a large-angle open state.

If there can only exist a stage where the auxiliary shaft 32 moves simultaneously closer to the second wall surface 24 and away from the first wall surface 23, that is, during an opening process of the door 200 and movement of the auxiliary shaft 32 along the fourth auxiliary shaft trajectory 62, relative to the door 200, the auxiliary shaft simultaneously moves closer to the second wall surface 24 and away from the first wall surface 23, then this can at least reduce the proportion of rotating end surface rotation, prevent interference, while leaving certain space for users to access items stored in the storage component.

In some embodiments, as shown in FIG. 3 or FIG. 9, FIG. 6 and FIG. 8, during an opening process of the door 200, there at least exists a stage where the main shaft 31 moves along the main shaft trajectory 5. It can be understood that during the opening process of the door 200, the main shaft 31 may have stages of maintaining position at certain locations in the main groove 21, and such position maintenance stages can exist in early, middle, and/or late stages of door 200 opening.

During movement of the auxiliary shaft 32 along the fourth auxiliary shaft trajectory 62, there exists a stage where the door 200 moves in a direction closer to the external environment component 400. Thus, this can not only complete the guidance of the door 200's rotational opening process through the auxiliary shaft 32, but also achieve large-angle rotational opening of the door 200, creating clearance on the access opening side, expanding the space available for users to access items stored in the storage component in a direction perpendicular to the external environment component 400, and building a positional foundation for subsequent large-angle opening along the first auxiliary shaft trajectory 64. It can be understood that the present application does not restrict the door 200 to always moving in the above direction during movement of the auxiliary shaft 32 along the fourth auxiliary shaft trajectory 62, nor does the present application restrict the door 200 to only undergo movement.

In an embodiment, as shown in FIG. 6, FIG. 7 and FIG. 8, during movement of the auxiliary shaft 32 relative to the door 200 along the fourth auxiliary shaft trajectory 62, the door 200 first moves in a direction closer to the external environment component 400, then moves in a direction away from the external environment component 400. Thus, this can first control the door 200 to open as a whole towards the side of the external environment component 400, and then control the door 200, especially the pivoting side of the door where the hinge assembly 300 is arranged, to move away from the external environment component 400, achieving the effect of large-angle opening.

Specifically, in states shown in FIG. 6 and FIG. 7, during an opening process of the door 200, relative to the door 200, the main shaft 31 moves in a direction away from the external environment component 400, the corresponding portion in the main groove 21 moves in a direction closer to the external environment component 400, and based on the principle of relative motion, the door 200 moves in a direction closer to the external environment component 400. In states shown in FIG. 7 and FIG. 8, if the fourth auxiliary shaft trajectory 62 extends to a side of the first auxiliary shaft trajectory 64, causing the movement direction of the main shaft 31 relative to the door 200 to reverse, then the main shaft 31 moves in a direction closer to the external environment component 400, the corresponding portion in the main groove 21 moves in a direction away from the external environment component 400, and based on the principle of relative motion, the door 200 moves away from the external environment component.

There is also an embodiment where the length of the fourth auxiliary shaft trajectory 62 is shortened, making the main shaft 21 always move in a direction away from the external environment component 400 during movement of the auxiliary shaft 32 along the fourth auxiliary shaft trajectory 62, then during movement of the auxiliary shaft 32 along the fourth auxiliary shaft trajectory 62, the door 200 always moves in a direction closer to the external environment component 400.

If defining a direction closer to the external environment component 400 as “outward” and a direction away from the external environment component 400 as “inward”, combined with the movement state of the door 200 when the auxiliary shaft 32 moves along the second auxiliary shaft trajectory 61 and the fourth auxiliary shaft trajectory 62, the movement mentioned above effectively achieves an “inward-outward-inward” opening action process of the door 200, effectively balancing the movement position of the door 200 in the inward and outward directions, avoiding excessive outward movement of the door 200 causing interference with the external environment component 400, and also avoiding excessive inward movement of the door 200 causing interference with another door in a double-door structure, or causing problems of occupying the access opening or interfering with internal components.

Correspondingly, during a closing process of the door 200 and movement of the auxiliary shaft 32 along the fourth auxiliary shaft trajectory 62, there exists a stage where the door 200 moves in a direction away from the external environment component 400. Thus, the door 200 quickly retracts inward away from the external environment component 400, similarly increasing the amplitude of closing and accelerating the closing process.

Specifically, in states shown in FIG. 6 and FIG. 7, during a closing process of the door 200, relative to the door 200, the main shaft 31 moves in a direction closer to the external environment component 400, the corresponding portion in the main groove 21 moves in a direction away from the external environment component 400, and based on the principle of relative motion, the door 200 moves in a direction away from the external environment component 400. In states shown in FIG. 7 and FIG. 8, if the fourth auxiliary shaft trajectory 62 extends to a side of the first auxiliary shaft trajectory 64, then before the above process, the main shaft 31 would first move in a direction away from the external environment component 400, the corresponding portion in the main groove 21 moves in a direction closer to the external environment component 400, and based on the principle of relative motion, the door 200 moves closer to the external environment component.

In a first example of an embodiment, as shown in FIG. 6 and FIG. 7, during an opening process of the door 200 and movement of the auxiliary shaft 32 along the fourth auxiliary shaft trajectory 62, the main shaft 31 moves along the second main shaft trajectory 52. When the auxiliary shaft 32 moves along the fourth auxiliary shaft trajectory 62, the door 200 moves simultaneously closer to the external environment component 400 and closer to the housing 100. Thus, this can prevent the door 200 from blocking the opening side of the housing 100 and prevent the door 200 from separating from the housing 100.

In a second example of this embodiment, during an opening process of the door 200 and movement of the auxiliary shaft 32 along the fourth auxiliary shaft trajectory 62, the main shaft 31 can, as mentioned above, first move along the second main shaft trajectory 52, controlling the door 200 to move closer to the external environment component 400, then move along the third main shaft trajectory 53, controlling the door 200 to move away from the external environment component 400. This case can exist in embodiments where the fourth auxiliary shaft trajectory 62 shown in FIG. 6 and FIG. 7 and the first auxiliary shaft trajectory 64 shown in FIG. 8 are uniformly defined as the second auxiliary shaft trajectory.

In an embodiment, as shown in FIG. 8, during an opening process of the door 200 and movement of the auxiliary shaft 32 along the first auxiliary shaft trajectory 64, the main shaft 31 moves along the third main shaft trajectory 53. When the auxiliary shaft 32 moves along the first auxiliary shaft trajectory 64, the door 200 moves simultaneously away from the external environment component 400 and away from the housing 100. Thus, this can assist the door 200 in opening to a larger angle while ensuring that the door 200 does not interfere with the external environment component 400.

In embodiments where the second auxiliary shaft trajectory 61 exists, the second auxiliary shaft trajectory 61 can be configured as a single circular arc, multiple circular arcs joined together, or generally in a shape of an irregular curve.

The second auxiliary shaft trajectory 61 is generally in a shape of a circular arc with equal radius, thereby assisting the door 200 in achieving smooth rotation in place.

In a first example, a radius of curvature of the second auxiliary shaft trajectory 61 is smaller than a radius of curvature of the fourth auxiliary shaft trajectory 62. In a second example, a curvature of the second auxiliary shaft trajectory 61 is greater than a curvature of the fourth auxiliary shaft trajectory 62. In a third example, between the second auxiliary shaft trajectory 61 and the fourth auxiliary shaft trajectory 62, both of the above conditions are simultaneously satisfied.

When the second auxiliary shaft trajectory 61 and/or the fourth auxiliary shaft trajectory 62 is a single circular arc, the curvature of the auxiliary shaft trajectory or radius of curvature of the auxiliary shaft trajectory can be the curvature or radius of curvature of this single circular arc. When the second auxiliary shaft trajectory 61 and/or the fourth auxiliary shaft trajectory 62 is formed by joining multiple circular arcs, or is in a shape of an irregular curve, the curvature of the auxiliary shaft trajectory or radius of curvature of the auxiliary shaft trajectory can be an average curvature or radius of curvature of this curve.

In embodiments where the third auxiliary shaft trajectory 63 exists, the third auxiliary shaft trajectory 63 is generally linear, which can be a single straight line as a whole, or can be formed by joining multiple straight line segments.

In embodiments where the first auxiliary shaft trajectory 64 exists, the first auxiliary shaft trajectory 64 is generally linear, similarly, which can be a single straight line as a whole, or can be formed by joining multiple straight line segments.

The main shaft trajectory 5 is generally in a shape of an elliptical arc, thus during movement of the auxiliary shaft 32 along the third auxiliary shaft trajectory 63, or movement of the auxiliary shaft 32 along the first auxiliary shaft trajectory 64, it guides the door 200 to achieve smoother rotational opening. The third main shaft trajectory 53, the first main shaft trajectory 51, and the second main shaft trajectory 52 are all included in the main shaft trajectory 5.

Among the above four movement processes, one can be selected for configuration, or multiple combinations can be selected for configuration.

The relationships between the configurations of the above four movement processes are “and/or” relationships.

Correspondingly, the above technical solutions of the present application can also achieve the technical effect of smooth and rapid rotational closing. The following processes can be carried out sequentially during a closing process of the door 200: as shown in FIG. 8, the auxiliary shaft 32 moves along the first auxiliary shaft trajectory 64, and the main shaft 31 moves along the third main shaft trajectory 53; as shown in FIG. 6 and FIG. 7, the auxiliary shaft 32 moves along the fourth auxiliary shaft trajectory 62, and the main shaft 31 moves along the second main shaft trajectory 52; as shown in FIG. 3 and FIG. 9, the auxiliary shaft 32 moves along the third auxiliary shaft trajectory 63, the main shaft 31 first moves along the second main shaft trajectory 52, then along the first main shaft trajectory 51; as shown in FIG. 4 and FIG. 5, the auxiliary shaft 32 moves along the second auxiliary shaft trajectory 61, the main shaft 31 rotates about itself, and the door 200 rotates in place with the main shaft 31 as a rotation axis.

In this first embodiment, the main shaft 31, auxiliary shaft 32, and door 200 can satisfy several relative positional relationships.

The storage component provided in the first embodiment of the present application can satisfy at least one of the following relationships. It can be understood that the relationships between the following positions can be “and” relationships or “or” relationships.

As shown in FIG. 5, in an embodiment, when the auxiliary shaft 32 moves to an end of the second auxiliary shaft trajectory 61, the main shaft 31 remains at an initial position P0 relative to the main groove 21; at this time, the opening angle of the door 200 can be around 14 degrees, such as 10 degrees, 12 degrees, 14 degrees, 16 degrees, 18 degrees, 20 degrees, etc.

As shown in FIG. 3 or FIG. 9, in an embodiment, when the main shaft 31 moves to an end of the first main shaft trajectory 51, the auxiliary shaft 32 can be located at the third auxiliary shaft trajectory 63; at this time, the opening angle of the door 200 can be around 45 degrees, such as 40 degrees, 43 degrees, 45 degrees, 47 degrees, 50 degrees, etc.

In an embodiment, when the main shaft 31 moves along the second main shaft trajectory 52 and returns to its initial position P0 (referring to a state before a state shown in FIG. 6 in conjunction with FIG. 9), the auxiliary shaft can be located at the third auxiliary shaft trajectory 63; at this time, the opening angle of the door 200 can be around 70 degrees, such as 65 degrees, 70 degrees, 75 degrees.

As shown in FIG. 6 in conjunction with FIG. 9, in an embodiment, when the auxiliary shaft 32 moves to an end of the third auxiliary shaft trajectory 63 (in an embodiment, this can be a starting point of the fourth auxiliary shaft trajectory 62), the main shaft 31 can be located between its initial position and an end of the second main shaft trajectory 52; at this time, the opening angle of the door 200 can be around 80 degrees, such as 78 degrees, 80 degrees, 82 degrees, 85 degrees, etc.

As shown in FIG. 7, in an embodiment, when the auxiliary shaft 32 moves to an end of the fourth auxiliary shaft trajectory 62, the main shaft 31 can be located at an end of the second main shaft trajectory 53 (or at an end of the main groove 21 closer to the first wall surface 23, such as an end of the third main shaft trajectory); at this time, the opening angle of the door 200 can be around 90 degrees, such as 88 degrees, 90 degrees, 92 degrees, 95 degrees, 97 degrees, 100 degrees, etc.

As shown in FIG. 8, in an embodiment, when the auxiliary shaft 32 moves to an end of the first auxiliary shaft trajectory 64, the main shaft 31 moves to an end of the third main shaft trajectory 53 and returns to its initial position P0; at this time, the opening angle of the door 200 can be around 110 degrees, such as 105 degrees, 110 degrees, 115 degrees, 118 degrees, 120 degrees, etc.

Furthermore, as shown in FIGS. 3 to 10, the first embodiment provided by the present application can include following technical details.

The storage component is arranged at a side of an external environment component 400, the door 200 includes a third wall surface 25 and a second wall surface 24 perpendicular to each other. When the door 200 closes the opening side 10 of the housing 100, the hinge assembly 300 is close to a first side face 41 of the external environment component 400. The third wall surface 25 is away from and parallel to a plane where the opening side 10 is located; the second wall surface 24 is close to and parallel to the first side face 41.

The third wall surface 25 intersects with the second wall surface 24 to form a first side edge 26.

The door also includes a first wall surface 23 perpendicular to the second wall surface 24. When the door 200 closes the opening side 10 of the housing 100, the first wall surface 23 is close to and parallel to a plane where the opening side 10 is located.

The first wall surface 23 intersects with the second wall surface 24 to form a second side edge 27.

In some embodiments, during an opening process of the door 200, the first side edge 26 moves along a first outer side edge trajectory L11.

The first outer side edge trajectory L11 is generally arc-shaped and protrudes in a direction away from the door 200.

During this process, the door 200 rotates in place with the main shaft 31 as a rotation axis, and the auxiliary shaft 32 moves along the second auxiliary shaft trajectory 61.

The first side edge 26 continues to move along a second outer side edge trajectory L12.

The second outer side edge trajectory L12 is generally linear.

The linear shape can be strictly straight, or can be approximately straight within a certain error range of deformation. This will not be repeated in the following text.

During this process, the main shaft 31 first moves along the first main shaft trajectory 51 in a direction closer to the first side edge 26, then moves along the second main shaft trajectory 52 in a direction away from the first side edge 26; the auxiliary shaft moves successively along the third auxiliary shaft trajectory 63 and the fourth auxiliary shaft trajectory 62.

During an opening process of the door 200, the main shaft 31 moves reciprocally within the main groove 21; the main groove 21 is generally in a shape of an elliptical arc. The main shaft trajectory 5 formed by the main shaft 31 in the main groove 21 can protrude in a direction away from the second wall surface 24.

In embodiments where the first wall surface 23 intersects with the second wall surface 24 to form a second side edge 27, the main groove 21 can protrude in a direction away from the second side edge 27. During an opening process of the door 200, the auxiliary shaft 32 consequently moves successively along a curved trajectory (such as the second auxiliary shaft trajectory 61), a linear trajectory (such as the third auxiliary shaft trajectory 63), and a curved trajectory (such as the fourth auxiliary shaft trajectory 62).

In some embodiments, during an opening process of the door 200, the first side edge 26 moves along the second outer side edge trajectory L12.

The second outer side edge trajectory L12 is generally linear.

During this process, the main shaft first moves along the first main shaft trajectory 51 in a direction closer to the first side edge 26, then moves along the second main shaft trajectory 52 in a direction away from the first side edge 26; the auxiliary shaft moves successively along the third auxiliary shaft trajectory 63 and the fourth auxiliary shaft trajectory 62.

The first side edge 26 continues to move along a third outer side edge trajectory L13 with varying radius of curvature.

The third outer side edge trajectory L13 is composed of at least two curves with different average radii of curvature, or at least two points on the third outer side edge trajectory L13 have different radii of curvature.

During this process, the main shaft 31 either continuously moves along the third main shaft trajectory 53 in a direction closer to the first side edge 26, or the main shaft 31 first moves along the second main shaft trajectory 52 then along the third main shaft trajectory 53; the auxiliary shaft 32 either continuously moves along the first auxiliary shaft trajectory 64, or the auxiliary shaft 32 moves successively along the fourth auxiliary shaft trajectory 62 and the first auxiliary shaft trajectory 64.

In some embodiments, during an opening process of the door 200, during movement of the first side edge 26 along the second outer side edge trajectory L12, the first side edge 26 can perform linear movement.

The linear movement can be strictly linear movement, or can be approximately linear movement within a certain error range of deformation. This will not be repeated in the following text.

The second outer side edge trajectory L12 is generally in a shape of a linear line extending perpendicular to a direction of the opening side 10 of the housing 100. The linear line can be formed by curves or joined curves with relatively large radius of curvature and/or small curvature, or can be formed by a single straight line segment or multiple joined straight line segments.

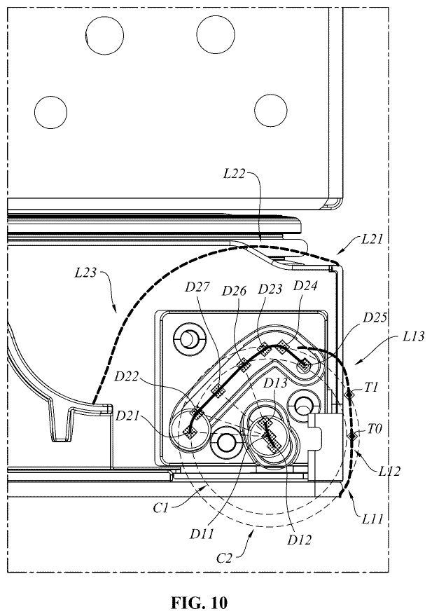

Specifically referring to FIG. 10, during this process, the first side edge 26 has a first closest position T0 relative to the external environment component 400 (particularly the first side face 41), and the first side edge 26 has a first farthest position T1 relative to the external environment component 400 (particularly the first side face 41). The first closest position T0 is on the second outer side edge trajectory L12. A perpendicular distance of the first closest position T0 from the first side face 41 is shortest compared to other points on the outer side edge trajectories. The first farthest position T1 is on the second outer side edge trajectory L12. a perpendicular distance of the first farthest position T1 from the first side face 41 is longest at least compared to other points on the second outer side edge trajectory L12.

The distance between the first closest position T0 and the first farthest position T1 along a first direction F1 is not greater than 0.5 mm. This distance equals the difference between the perpendicular distance from the first farthest position T1 to the first side face 41 and the perpendicular distance from the first closest position T0 to the first side face 41.

The first direction F1 is perpendicular to the first side face 41.

The first outer edge trajectory L12 lies in a first plane, which is perpendicular to the first side face 41. Drawing a line parallel to the first side face 41 in the first plane through a farthest point from the first side face 41 on the first outer edge trajectory L12 (for example, the first farthest position T1) yields a first line; drawing a line parallel to the first side face 41 in the first plane through a closest point from the first side face 41 on the first outer edge trajectory L12 (for example, the first closest position T0) yields a second line.

During movement of the first side edge 26 along the second outer side edge trajectory L12, the second outer side edge trajectory L12 can be viewed as being between the first line and the second line; the distance between the first line and the second line is not greater than 0.5 mm.

When the second outer side edge trajectory L12 is generally linear extending along a second direction F2, the distance between the first closest position T0 and the first farthest position T1 along the first direction F1 is not greater than 0.2 mm.

The second direction F2 is perpendicular to a plane where the opening side 10 of the housing 100 is located.

During movement of the first side edge 26 along the second outer side edge trajectory L12, the second outer side edge trajectory L12 can be viewed as being between two lines. If the second outer side edge trajectory L12 is linear, the distance between these two lines is not greater than 0.2 mm; both lines are parallel to the first side face 41.

In some embodiments, during an opening process of the door 200, the first side edge 26 performs curved movement along the third outer side edge trajectory L13 with varying radius of curvature. The first side edge 26 performs at least circular arc movement along the first outer side edge trajectory L11, and the first outer side edge trajectory L11 protrudes in a direction away from the door 200.

The circular arc movement can be strictly circular arc movement, or can be approximately circular arc movement within a certain error range of deformation. This will not be repeated in the following text.

The first side edge 26 moves successively along the first outer side edge trajectory L11 and the third outer side edge trajectory L13.

The first outer side edge trajectory L11 is generally arc-shaped, and when the first side edge 26 moves along the first outer side edge trajectory L11, the door 200 can rotate in place. Between the first outer side edge trajectory L11 and the third outer side edge trajectory L13, there can exist a second outer side edge trajectory L12.

The second outer side edge trajectory L12 is generally linear.

In some embodiments, the second side edge 27 moves along a first inner side edge trajectory L21.

The first inner side edge trajectory L21 is generally arc-shaped and protrudes in a direction away from the door 200.

During this process, the door 200 rotates in place with the main shaft 31 as a rotation axis, and the auxiliary shaft 32 moves along the second auxiliary shaft trajectory 61.

The second side edge 27 moves successively along a second inner side edge trajectory L22 and a third inner side edge trajectory L23.

The average radius of curvature of the second inner side edge trajectory L22 is different from the average radius of the third inner side edge trajectory L23.

At least two points on the second inner side edge trajectory L22 have different radii of curvature, and/or at least two points on the third inner side edge trajectory L23 have different radii of curvature.

During this process, the main shaft 31 first moves along the first main shaft trajectory 51 in a direction closer to the first side edge 26, then moves along the second main shaft trajectory 52 in a direction away from the first side edge 26, and finally moves along the third main shaft trajectory 53 in a direction closer to the first side edge 26; the auxiliary shaft moves successively along the third auxiliary shaft trajectory 63, the fourth auxiliary shaft trajectory 62, and the first auxiliary shaft trajectory 64.

During an opening process of the door, the main shaft 31 moves reciprocally within the main groove 21; the main groove 21 is generally in a shape of an elliptical arc. The main groove 21 extends in a direction of the first side edge 26. The main shaft trajectory 5 formed by the main shaft 31 in the main groove 21 can protrude in a direction away from the second wall surface 24.

In embodiments where the first wall surface 23 intersects with the second wall surface 24 to form a second side edge 27, the main groove 21 can protrude in a direction away from the second side edge 27. During an opening process of the door 200, the auxiliary shaft 32 consequently moves successively along a curved trajectory (such as the second auxiliary shaft trajectory 61), a linear trajectory (such as the third auxiliary shaft trajectory 63), a curved trajectory (such as the fourth auxiliary shaft trajectory 62), and a linear trajectory (such as the first auxiliary shaft trajectory 64).

In some embodiments, center points of the main shaft 31 and auxiliary shaft 32 can be used to define their current positions relative to the groove. For example, defining a starting point of the first main shaft trajectory 51 as a first main shaft reference point D11; defining a starting point of the second main shaft trajectory 52 as a second main shaft reference point D12; defining a starting point of the third main shaft trajectory 53 as a third main shaft reference point D13. For example, defining a starting point of the second auxiliary shaft trajectory 61 as a first auxiliary shaft reference point D21; defining a starting point of the third auxiliary shaft trajectory 63 as a second auxiliary shaft reference point D22; defining a starting point of the second auxiliary shaft trajectory 61 as a third auxiliary shaft reference point D23; defining a starting point of the first auxiliary shaft trajectory 64 as a fourth auxiliary shaft reference point D24.

When the auxiliary shaft 32 is at the first auxiliary shaft reference point D21, the main shaft 31 is at the first main shaft reference point D11. When the auxiliary shaft 32 is at the second auxiliary shaft reference point D22, the main shaft 31 is at the first main shaft reference point D11. When the auxiliary shaft 32 is at the third auxiliary shaft reference point D23, the main shaft 31 is between the first main shaft reference point D11 and the third main shaft reference point D13. When the auxiliary shaft 32 is at the fourth auxiliary shaft reference point D24, the main shaft 31 is at the third main shaft reference point D13.

The distance between the first auxiliary shaft reference point D21 and the first main shaft reference point D11 equals a first shaft spacing distance, and the distance between the second auxiliary shaft reference point D22 and the first main shaft reference point D11 equals a second shaft spacing distance.

The first shaft spacing distance equals the second shaft spacing distance.

Using the first main shaft reference point D11 as a center and the first shaft spacing distance or the second shaft spacing distance as the radius, draw a first reference circle C1; both the first auxiliary shaft reference point D21 and the second auxiliary shaft reference point D22 are on the first reference circle C1.

The angle between a line connecting the first auxiliary shaft reference point D21 and the first main shaft reference point D11, and a line connecting the second auxiliary shaft reference point D22 and the first main shaft reference point D11 is about 14 degrees.

On the first reference circle C1, the central angle of an arc segment between the first auxiliary shaft reference point D21 and the second auxiliary shaft reference point D22 is about 14 degrees.

The distance between the third auxiliary shaft reference point D23 and the first main shaft reference point D11 equals a third shaft spacing distance, and the distance between the fourth auxiliary shaft reference point D24 and the first main shaft reference point D11 equals a fourth shaft spacing distance.

The third shaft spacing distance is greater than both the first shaft spacing distance and the second shaft spacing distance. The fourth shaft spacing distance is greater than both the first shaft spacing distance and the second shaft spacing distance.

The fourth shaft spacing distance is greater than the third shaft spacing distance.

The distance between the first main shaft reference point D11 and the second wall surface 24 equals a first width distance, and the distance between the first main shaft reference point D11 and the third wall surface 25 equals a first thickness distance.

The first width distance is greater than the first thickness distance.

The difference between the fourth shaft spacing distance and the first shaft spacing distance equals the difference between the fourth shaft spacing distance and the second shaft spacing distance, and equals the difference between the first width distance and the first thickness distance.

Using the first main shaft reference point D11 as a center and the fourth shaft spacing distance as the radius, draw a second reference circle C2; the fourth auxiliary shaft reference point D24 is on the second reference circle C2; the radius of the second reference circle C2 is greater than the radius of the first reference circle C1; the difference between the radii of the second reference circle C2 and the radii of the first reference circle C2 equals the difference between the first width distance and the first thickness distance.

Defining the first width distance as x1, the first thickness distance as y1, the maximum opening angle of the door 200 as W, and the distance between the second wall surface 24 and the first side face 41 when the door is closed as A, then the first width distance x1 must satisfy at least: x1=y1●tan W−A.

The first width distance is any value from 10 mm to 20 mm, such as 10 mm, 11 mm, 15 mm, 18 mm, 20 mm. The first thickness distance is any value from 8 mm to 18 mm, such as 8 mm, 10 mm, 13 mm, 15 mm, 18 mm.

The angle between a line connecting the third auxiliary shaft reference point D23 and the first main shaft reference point D11, and a line connecting the first auxiliary shaft reference point D21 and the first main shaft reference point D11 is about 80 degrees.

On the first reference circle C1, the central angle of an arc segment between the first auxiliary shaft reference point D21 and the third auxiliary shaft reference point D23 is about 80 degrees. The angle between a line connecting the fourth auxiliary shaft reference point D24 and the first main shaft reference point D11, and a line connecting the first auxiliary shaft reference point D21 and the first main shaft reference point D11 is about 90 degrees.

On the first reference circle C1, the central angle of an arc segment between the first auxiliary shaft reference point D21 and the fourth auxiliary shaft reference point D24 is about 90 degrees.

An endpoint of the second auxiliary shaft trajectory 61 can be the second auxiliary shaft reference point D22. An endpoint of the third auxiliary shaft trajectory 63 can be the third auxiliary shaft reference point D23. An endpoint of the fourth auxiliary shaft trajectory 62 can be the fourth auxiliary shaft reference point D24. The first auxiliary shaft trajectory 64 can include a fifth auxiliary shaft reference point D25 as an endpoint of the first auxiliary shaft trajectory.

When the auxiliary shaft 32 is at the fifth auxiliary shaft reference point D25, the main shaft 31 is at the first main shaft reference point D11.

The distance between the fifth auxiliary shaft reference point D25 and the first main shaft reference point D11 equals a fifth shaft spacing distance.

The fifth shaft spacing distance equals the first shaft spacing distance; the fifth shaft spacing distance equals the second shaft spacing distance.

Using the first main shaft reference point D11 as a center and the first shaft spacing distance or the second shaft spacing distance or the fifth shaft spacing distance as the radius, draw the first reference circle C1; the first auxiliary shaft reference point D21, the second auxiliary shaft reference point D22, and the fifth auxiliary shaft reference point D25 are all on the first reference circle C1.

The angle between a line connecting the first auxiliary shaft reference point D21 and the first main shaft reference point D11, and a line connecting the fifth auxiliary shaft reference point D25 and the first main shaft reference point D11 is about 110 degrees.

On the first reference circle C1, the central angle of an arc segment between the first auxiliary shaft reference point D21 and the fifth auxiliary shaft reference point D25 is about 110 degrees.

Between the second auxiliary shaft reference point D22 and the third auxiliary shaft reference point D23, or between the first auxiliary shaft reference point D21 and the third auxiliary shaft reference point D23, there is a sixth auxiliary shaft reference point D26.

When the auxiliary shaft 32 is at the sixth auxiliary shaft reference point D26, the main shaft is at the first main shaft reference point D11.

The distance between the sixth auxiliary shaft reference point D26 and the first main shaft reference point D11 equals a sixth shaft spacing distance.

The sixth shaft spacing distance equals the first shaft spacing distance. The sixth shaft spacing distance equals the second shaft spacing distance. The sixth shaft spacing distance equals the fifth shaft spacing distance.

Using the first main shaft reference point D11 as a center and the first shaft spacing distance, second shaft spacing distance, fifth shaft spacing distance, or sixth shaft spacing distance as the radius, draw the first reference circle C1; the first auxiliary shaft reference point D21, second auxiliary shaft reference point D22, fifth auxiliary shaft reference point D25, and sixth auxiliary shaft reference point D26 are all on the first reference circle C1.

The angle between a line connecting the sixth auxiliary shaft reference point D26 and the first main shaft reference point D11, and a line connecting the first auxiliary shaft reference point D21 and the first main shaft reference point D11 is about 70 degrees.

On the first reference circle C1, the central angle of an arc segment between the first auxiliary shaft reference point D21 and the sixth auxiliary shaft reference point D26 is about 70 degrees.

Between the sixth auxiliary shaft reference point D26 and the first auxiliary shaft reference point D21, or between the sixth auxiliary shaft reference point D26 and the second auxiliary shaft reference point D22, there is a seventh auxiliary shaft reference point D27.

When the auxiliary shaft 32 is at the seventh auxiliary shaft reference point D27, the main shaft is at the second main shaft reference point D12.

The distance between the seventh auxiliary shaft reference point D27 and the first main shaft reference point D11 equals a seventh shaft spacing distance. The seventh shaft spacing distance is less than the first shaft spacing distance. The seventh shaft spacing distance is less than the second shaft spacing distance. The seventh shaft spacing distance is less than the fifth shaft spacing distance; the seventh shaft spacing distance is less than the sixth shaft spacing distance.

Using the first main shaft reference point D11 as a center and the first shaft spacing distance, second shaft spacing distance, fifth shaft spacing distance, or sixth shaft spacing distance as the radius, draw the first reference circle C1; the seventh auxiliary shaft reference point D27 is inside the first reference circle C1.

The angle between a line connecting the first auxiliary shaft reference point D21 and the first main shaft reference point D11, and a line connecting the seventh auxiliary shaft reference point D27 and the first main shaft reference point D11 is about 45 degrees.

The radius of the first reference circle C1 can be any value between 12 mm and 25 mm. For example, 12 mm, 15 mm, 18 mm, 20 mm, 23 mm, 25 mm.

The seventh auxiliary shaft reference point D27 is located on a line connecting the second auxiliary shaft reference point D22 and the sixth auxiliary shaft reference point D26.

The seventh auxiliary shaft reference point D27 is located at the midpoint of this line.

The drawings of the detailed descriptions for the above-provided embodiments all describe the technical solution where the shaft is fixed to the housing 100 and the groove is fixed to the door 200.

The present application does not exclude technical solutions where the shaft is arranged on the door 200 and the groove is arranged on the housing 100, or where one shaft is arranged on the door 200 and another shaft is arranged on the housing 100. Based on such transformed technical solutions, those skilled in the art can achieve the effects provided above by adjusting the movement direction of the shaft.

Such changes in shaft-groove positions, without departing from the concept of the present application, may fall within the scope of protection of the present application.

The above-provided embodiments are mostly described in terms of the opening process of the door, but those skilled in the art are capable of deriving corresponding solutions for the closing process of the door.

In an embodiment, the storage component is arranged at a side of an external environment component 400, and the door 200 includes a third wall surface 25 and a second wall surface 24 perpendicular to each other. When the door 200 closes the opening side 10 of the housing 100, the hinge assembly 300 is close to a first side face 41 of the external environment component 400; the third wall surface 25 is away from and parallel to a plane where the opening side 10 is located; the second wall surface 24 is close to and parallel to the first side face 41. The third wall surface 25 intersects with the second wall surface 24 to form a first side edge 26.

When the auxiliary shaft 32 moves to an end of the second auxiliary shaft trajectory 61 (a starting point of the third auxiliary shaft trajectory) and the door 200 continues to open from the current position of the door, the distance along the first direction F1 between the first closest position T0 of the first side edge 26 relative to the external environment component 400 and the first farthest position T1 of the first side edge 26 relative to the external environment component 400 is not greater than 0.5 mm.

When at least part of the outer edge trajectory of the first side edge 26 is generally linear along the second direction F2, the distance along the first direction F1 between the first closest position T0 and the first farthest position T1 is not greater than 0.2 mm.

The first direction F1 is perpendicular to the first side face 41, and the second direction F2 is perpendicular to a plane where the opening side 10 of the housing 100 is located.

In summary, the storage component provided by the present application can enhance pivoting stability by setting a stage where the auxiliary shaft moves along a linear line during a pivoting process of the door.

In an embodiment, during an opening process of the door, configuring the shaft for guiding door rotation to move along a linear line and configuring the shaft for driving door rotation to move along a curved line not only allows the door to rotate normally but also avoids abnormal interference damage to the shaft caused by processing factors between the shaft and groove, thereby achieving the effects of extending service life and reducing costs; since the auxiliary shaft and main shaft are configured to move along linear lines and curved lines respectively and simultaneously, under a same opening angle, the position change of the main shaft is less compared to the prior art, making the door rotation opening process more stable and helping achieve rapid door opening.

In an embodiment, during an opening process of the door, configuring the shaft for guiding door rotation to first move along a linear trajectory and then along a curved trajectory can help the door first generate translation amount and then generate rotation amount, and can achieve self-adaptation by adjusting the lengths of the two trajectories; moreover, since the curved trajectory is configured to be entirely on the door opening direction side of the linear trajectory, it can effectively improve the smoothness during the opening process and avoid aging and damage caused by structural interference.

In an embodiment, during a closing process of the door, configuring the shaft for guiding door rotation to first move along a linear trajectory and then along a curved trajectory can help the door first generate translation amount and then generate rotation amount, and can achieve self-adaptation by adjusting the lengths of the two trajectories; moreover, since the curved trajectory is configured to be entirely on the door closing direction side of the linear trajectory, it can effectively improve the smoothness during a closing process and avoid aging and damage caused by structural interference.

It should be understood that although this detailed descriptions is described in terms of embodiments, not every embodiment contains only a single independent technical solution. This narrative approach in the detailed descriptions is solely for the purpose of clarity. Those skilled in the art should consider the detailed descriptions as a whole, and the technical solutions in various embodiments may also be appropriately combined to form other embodiments understandable to those skilled in the art.

The series of detailed descriptions provided above are merely specific explanations regarding feasible embodiments of the present application and are not intended to limit the scope of protection thereof. Any equivalent embodiments or modifications made without departing from the spirit of the application shall fall within the protection scope of the present application.

1. A storage component, comprising a housing, a door and a hinge assembly;
wherein the door is pivotally connected to an opening side of the housing through the hinge assembly; the hinge assembly comprises a main shaft, an auxiliary shaft configured to provide guidance for rotation of the door, a main groove corresponding to the main shaft, and an auxiliary groove corresponding to the auxiliary shaft;
during a pivoting process of the door, there exists a stage where the auxiliary shaft moves along an auxiliary shaft trajectory which is generally linear as a whole.

2. The storage component according to claim 1, wherein the storage component is arranged at a side of an external environment component, the main shaft is fixed to the housing, and the main groove is fixed to the door; when the door closes the opening side of the housing, the hinge assembly is close to the external environment component;
during an opening process of the door, relative to the door, the main shaft has a movement component in a direction towards a side close to the external environment component, so as to prevent interference between the door and the external environment component.

3. The storage component according to claim 1, wherein the storage component is arranged at a side of an external environment component, the door comprises a first wall surface and a second wall surface perpendicular to each other, when the door closes the opening side of the housing, the first wall surface is close to and parallel to a plane where the opening side is located, and the second wall surface is close to and parallel to a first side face of the external environment component;
during an opening process of the door and movement of the auxiliary shaft along a first auxiliary shaft trajectory, relative to the door, there exists a stage where the auxiliary shaft moves simultaneously closer to the second wall surface and away from the first wall surface; and/or,
during an opening process of the door and movement of the auxiliary shaft along a fourth auxiliary shaft trajectory, relative to the door, there exists a stage where the auxiliary shaft moves simultaneously closer to the second wall surface and away from the first wall surface, or there exists a stage where the auxiliary shaft moves simultaneously closer to the second wall surface and closer to the first wall surface.

4. The storage component according to claim 1, wherein the storage component is arranged at a side of an external environment component, the door comprises a first wall surface and a second wall surface perpendicular to each other, when the door closes the opening side of the housing, the first wall surface is close to and parallel to a plane where the opening side is located, and the second wall surface is close to and parallel to the first side face of the external environment component;
relative to the door, when the main shaft moves along a first main shaft trajectory, it moves simultaneously closer to the second wall surface and away from the first wall surface; and/or, relative to the door, when the main shaft moves along a second main shaft trajectory, it moves simultaneously away from the second wall surface and closer to the first wall surface; and/or,
during an opening process of the door, there successively exists a stage where the main shaft moves along the first main shaft trajectory, a stage where the main shaft moves along the second main shaft trajectory and a stage where the main shaft moves along a third main shaft trajectory; a sum of lengths of the third main shaft trajectory and the first main shaft trajectory equals to a length of the second main shaft trajectory.

5. The storage component according to claim 1, wherein when the auxiliary shaft moves along a second auxiliary shaft trajectory, the main shaft rotates about itself, and the door rotates in place with the main shaft as a rotation axis; and/or,
when the auxiliary shaft moves along a third auxiliary shaft trajectory, the main shaft first moves along a first main shaft trajectory and then moves along a second main shaft trajectory, the door first moves simultaneously away from an external environment component and closer to the housing, then moves simultaneously closer to the external environment component and away from the housing, and finally moves simultaneously closer to the external environment component and closer to the housing; and/or,
when the auxiliary shaft moves along a fourth auxiliary shaft trajectory, the main shaft moves along a second main shaft trajectory, and the door moves simultaneously closer to an external environment component and closer to the housing; and/or,
when the auxiliary shaft moves along a first auxiliary shaft trajectory, the main shaft moves along a third main shaft trajectory, and the door moves simultaneously away from the external environment component and away from the housing.

6. The storage component according to claim 5, wherein the second auxiliary shaft trajectory is generally in a shape of a circular arc with equal radius, and the main shaft trajectory is generally in a shape of an elliptical arc.

7. The storage component according to claim 1, wherein when the auxiliary shaft moves to an end of a second auxiliary shaft trajectory, the main shaft remains at an initial position relative to the main groove, and an opening angle of the door is 14 degrees; and/or,
when the main shaft moves to an end of a first main shaft trajectory, the auxiliary shaft is located at a third auxiliary shaft trajectory, and an opening angle of the door is 45 degrees; and/or,
when the main shaft moves and returns to its initial position, the auxiliary shaft is located at a third auxiliary shaft trajectory, and an opening angle of the door is 70 degrees; and/or,
when the auxiliary shaft moves to an end of a third auxiliary shaft trajectory, the main shaft is located between its initial position and an end of the second main shaft trajectory, and an opening angle of the door is 80 degrees; and/or,
when the auxiliary shaft moves to an end of a fourth auxiliary shaft trajectory, the main shaft is located at an end of the second main shaft trajectory or the third main shaft trajectory, and an opening angle of the door is 90 degrees; and/or,
when the auxiliary shaft moves to an end of a first auxiliary shaft trajectory, the main shaft moves to an end of a third main shaft trajectory and returns to its initial position, and an opening angle of the door is 110 degrees.

8. The storage component according to claim 1, wherein the door comprises a third wall surface perpendicular to a second wall surface; when the door closes the opening side of the housing, the third wall surface is away from and parallel to a plane where the opening side is located; the third wall surface intersects with the second wall surface to form a first side edge;
when the auxiliary shaft moves to a starting point of the third auxiliary shaft trajectory and the door continues to open from the current position of the door, a distance along a first direction between a first closest position of the first side edge relative to an external environment component and a first farthest position of the first side edge relative to the external environment component is not greater than 0.2 mm, and during this process, a first outer side edge trajectory of the first side edge is generally linear along a second direction;
wherein the first direction is perpendicular to a first side face, and the second direction is perpendicular to a plane where the opening side of the housing is located.

9. The storage component according to claim 1, wherein during an opening process of the door, the main shaft moves along a third main shaft trajectory, while the auxiliary shaft moves along a first auxiliary shaft trajectory; the third main shaft trajectory is generally curved, and the first auxiliary shaft trajectory is generally linear.

10. The storage component according to claim 9, wherein the door comprises a first wall surface and a second wall surface perpendicular to each other, when the door closes the opening side of the housing, the first wall surface is close to and parallel to a plane where the opening side is located, and the second wall surface is close to and parallel to a first side face of an external environment component;
during a process where the door continues to open from 90 degrees, when the main shaft moves along a third main shaft trajectory, the auxiliary shaft moves along a first auxiliary shaft trajectory; and/or,
during an opening process of the door and movement of the main shaft along a third main shaft trajectory, relative to the door, there exists a stage where the main shaft moves simultaneously closer to the second wall surface and away from the first wall surface; and/or,
during movement of the auxiliary shaft along a first auxiliary shaft trajectory, there exists a stage where the door moves in a direction away from the external environment component; and/or,
during movement of the auxiliary shaft along a first auxiliary shaft trajectory, there exists a stage where the door moves simultaneously away from the external environment component and away from the housing; and/or,
during an opening process of the door, there exists a stage where the main shaft moves along a first main shaft trajectory and a stage where the main shaft moves along a second main shaft trajectory; and/or,
there exists a stage where the auxiliary shaft moves along a third auxiliary shaft trajectory and a stage where the auxiliary shaft moves along a fourth auxiliary shaft trajectory, wherein the third auxiliary shaft trajectory is generally linear, and the fourth auxiliary shaft trajectory is generally curved; the third main shaft trajectory protrudes towards a side away from the second wall surface; and/or,
the third main shaft trajectory is generally in a shape of an elliptical arc.

11. The storage component according to claim 1, wherein the storage component is arranged at a side of an external environment component; the door comprises a second wall surface; when the door closes the opening side of the housing, the hinge assembly is close to a first side face of the external environment component, and the second wall surface is close to and parallel to the first side face;
during an opening process of the door, relative to the door, there successively exists a stage where the auxiliary shaft moves along a third auxiliary shaft trajectory and a stage where the auxiliary shaft moves along a fourth auxiliary shaft trajectory; the third auxiliary shaft trajectory is generally linear, and the fourth auxiliary shaft trajectory is generally curved; the fourth auxiliary shaft trajectory is entirely located on a side of the third auxiliary shaft trajectory closer to the second wall surface.

12. The storage component according to claim 11, wherein during the transition from moving along the third auxiliary shaft trajectory to moving along the fourth auxiliary shaft trajectory, an angle between a movement direction of the auxiliary shaft and the second wall surface gradually increases from an acute angle; and/or,
during movement of the auxiliary shaft along the third auxiliary shaft trajectory, there exists a stage where the door moves in a direction away from the external environment component; and/or,
during movement of the auxiliary shaft along the fourth auxiliary shaft trajectory, there exists a stage where the door moves in a direction closer to the external environment component; and/or,
during movement of the auxiliary shaft along the third auxiliary shaft trajectory, the door first moves in a direction away from the external environment component, then moves in a direction closer to the external environment component; and/or,
during movement of the auxiliary shaft along the fourth auxiliary shaft trajectory, the door first moves in a direction closer to the external environment component, then moves in a direction away from the external environment component; and/or,
during an opening process of the door and movement of the auxiliary shaft along the third auxiliary shaft trajectory, relative to the door, there exists a stage where the auxiliary shaft moves simultaneously closer to the second wall surface and closer to a first wall surface; and/or,
during an opening process of the door and movement of the auxiliary shaft along the fourth auxiliary shaft trajectory, relative to the door, the auxiliary shaft first moves simultaneously closer to the second wall surface and closer to a first wall surface, then moves simultaneously closer to the second wall surface and away from the first wall surface; and/or,
during an opening process of the door, the main shaft moves along a main shaft trajectory, the main shaft trajectory includes at least a curved section, and the curved section protrudes towards a side away from the second wall surface; and/or,
relative to the door, when the main shaft moves along the third main shaft trajectory, it moves simultaneously closer to the second wall surface and away from a first wall surface; the third main shaft trajectory is generally in a shape of an elliptical arc; and/or,
the first auxiliary shaft trajectory is generally linear.

13. The storage component according to claim 1, wherein the storage component is arranged at a side of an external environment component; the door comprises a second wall surface; when the door closes the opening side of the housing, the hinge assembly is close to a first side face of the external environment component, and the second wall surface is close to and parallel to the first side face;
during a closing process of the door, relative to the door, there successively exists a stage where the auxiliary shaft moves along a first auxiliary shaft trajectory and a stage where the auxiliary shaft moves along a fourth auxiliary shaft trajectory; the first auxiliary shaft trajectory is generally linear, and the fourth auxiliary shaft trajectory is generally curved; the fourth auxiliary shaft trajectory is entirely located on a side of the first auxiliary shaft trajectory away from the second wall surface.

14. The storage component according to claim 13, wherein the door comprises a first wall surface and a second wall surface perpendicular to each other, when the door closes the opening side of the housing, the first wall surface is close to and parallel to a plane where the opening side is located, and the second wall surface is close to and parallel to the first side face of the external environment component;
during the transition from moving along the first auxiliary shaft trajectory to moving along the fourth auxiliary shaft trajectory, an angle between a movement direction of the auxiliary shaft and the second wall surface gradually increases from an acute angle; and/or,
during an opening process of the door and movement of the auxiliary shaft along the first auxiliary shaft trajectory, there exists a stage where the door moves in a direction away from the external environment component; and/or,
during an opening process of the door and movement of the auxiliary shaft along the fourth auxiliary shaft trajectory, there exists a stage where the door moves in a direction closer to the external environment component; and/or,
during an opening process of the door and movement of the auxiliary shaft along the first auxiliary shaft trajectory, relative to the door, there exists a stage where the auxiliary shaft moves simultaneously closer to the second wall surface and away from the first wall surface; and/or,
during an opening process of the door and movement of the auxiliary shaft along the fourth auxiliary shaft trajectory, relative to the door, the auxiliary shaft first moves simultaneously closer to the second wall surface and closer to the first wall surface, then moves simultaneously closer to the second wall surface and away from the first wall surface; and/or,
during an opening process of the door, the main shaft moves along a main shaft trajectory, the main shaft trajectory includes at least a curved section, and the curved section protrudes towards a side away from the second wall surface; and/or,
during an opening process of the door, relative to the door, when the main shaft moves along the third main shaft trajectory, there exists a stage where the main shaft moves simultaneously closer to the second wall surface and away from the first wall surface; the third main shaft trajectory is generally in a shape of an elliptical arc; and/or,
the first auxiliary shaft trajectory is generally linear.

15. A refrigerator, comprising the storage component according to claim 1.
